(19) United States
(12) Patent Application Publication
(10) Pub. No.: US 2026/0003900 A1
(43) Pub. Date: Jan. 1, 2026

(54) SYSTEMS AND METHODS FOR GENERATIVE ARTIFICIAL INTELLIGENCE-ENABLED INTENT RESOLUTION

(71) Applicant: Synchrony Bank, Stamford, CT (US)

(72) Inventors: Kenneth Hashimoto, Stamford, CT (US); Becca Williams, Stamford, CT (US); Jennifer Cantor, Stamford, CT (US); Jeremy Mack, Stamford, CT (US); Jordan H. Taler, Stamford, CT (US)

(21) Appl. No.: 19/252,233

(22) Filed: Jun. 27, 2025

Related U.S. Application Data
(60) Provisional application No. 63/665,635, filed on Jun. 28, 2024.

(51) Int. Cl. G06F 16/334; G06F 40/30; H04L 51/02

(52) U.S. Cl. CPC G06F 16/334; G06F 40/30; H04L 51/02

(57) ABSTRACT

Systems and methods provide a framework through which generative artificial intelligence-enabled systems are implemented to provide real-time intent analysis and resolution. In response to user queries communicated by different users, the user queries are converted into different sets of embeddings that are evaluated according to different data sources made available through a Retrieval Augmented Generation (RAG) processor. Based on these different data sources and the different sets of embeddings, the RAG processor and one or more Large Language Models (LLMs) and/or generative artificial intelligence processes dynamically generate relevant responses to these different user queries.

### CROSS REFERENCE TO RELATED APPLICATIONS

This application claims the benefit of U.S. Provisional Patent Application 63/665,635, filed Jun. 28, 2024, which is incorporated herein by reference in its entirety for all purposes.

### FIELD

The present disclosure relates generally to a framework through which generative artificial intelligence-enabled systems are implemented to provide real-time intent analysis and resolution.

### SUMMARY

Disclosed embodiments provide a framework through which generative artificial intelligence-enabled systems are implemented to provide real-time intent analysis and resolution. According to some embodiments, a computer-implemented method is provided. The computer-implemented method comprises receiving a user query. The user query is associated with an intent. Further, the user query is received during an ongoing communications session between a user and an automated agent. The computer-implemented method further comprises dynamically converting the user query into a set of embeddings. The set of embeddings are obtained through language processing of the user query. The computer-implemented method further comprises identifying a set of response embeddings. The set of response embeddings correspond to one or more data sources relevant to the user query. Further, the set of response embeddings are identified through processing of the set of embeddings and different response embeddings according to a set of similarity vectors. The computer-implemented method further comprises generating a response to the user query and the intent. The response is generated by one or more generative pre-trained transformers according to the set of response embeddings. The computer-implemented method further comprises providing the response to the user query. The response is provided by the automated agent through the ongoing communications session. The computer-implemented method further comprises updating the one or more generative pre-trained transformers according to feedback associated with the response.

In some embodiments, the computer-implemented method further comprises receiving a new user query. The new user query is associated with an impermissible intent. The computer-implemented method further comprises automatically rejecting the new user query. The new user query is automatically rejected based on the impermissible intent.

In some embodiments, the set of embeddings and the different response embeddings are processed using retrieval augmented generation to identify the set of response embeddings.

In some embodiments, the computer-implemented method further comprises receiving a new user query. The new user query is associated with a known intent. The computer-implemented method further comprises automatically transmitting a known response to the new user query through the ongoing communications session. The known response is identified through a matching of a set of new embeddings corresponding to the new user query and a set of known response embeddings corresponding to the known response.

In some embodiments, the computer-implemented method further comprises identifying a role associated with the user. The computer-implemented method further comprises selecting the one or more data sources according to the role.

In some embodiments, the computer-implemented method further comprises storing a record of the response to the user query. The record is associated with the user. The computer-implemented method further comprises automatically surfacing the record in response to user initiation of a new communications session.

In some embodiments, the computer-implemented method further comprises evaluating the response through one or more other generative pre-trained transformers according to a set of controls. The response is provided as a result the response satisfying the set of controls.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a user communication system, through a Retrieval Augmented Generation (RAG) processor, dynamically processes user queries to generate automated responses to the user queries in accordance with at least one embodiment;

FIG. 2 shows an illustrative example of an environment in which an intent analyzer dynamically processes a user query to generate a set of embeddings and to evaluate the set of embeddings according to known responses in accordance with at least one embodiment;

FIG. 3 shows an illustrative example of an environment in which a RAG processor dynamically processes a set of user query embeddings to identify different relevant data embeddings for generation of a relevant response to the user query in accordance with at least one embodiment;

FIG. 4 shows an illustrative example of an environment in which a response supervisor evaluates a proposed user query response generated by the intent analyzer or RAG processor to determine whether the user query response can be provided to a user in accordance with at least one embodiment;

FIG. 5 shows an illustrative example of an environment in which a user communication system detects a user query associated with an impermissible intent and generates a response according to the impermissible intent in accordance with at least one embodiment;

FIG. 6 shows an illustrative example of an environment in which a user communication system provides user query responses according to a detected user intent expressed in a user query in accordance with at least one embodiment;

FIG. 7 shows an illustrative example of an environment in which a user communication system provides a user query response including resources for addressing a detected user intent expressed in a user query in accordance with at least one embodiment;

FIG. 8 shows an illustrative example of a process for evaluating a set of embeddings corresponding to a user query according to a set of applicable rules and known responses to determine how to process the user query in accordance with at least one embodiment;

FIG. 9 shows an illustrative example of a process for generating a user query response to a user query through a RAG processor and based on identified relevant data embeddings in accordance with at least one embodiment; and

FIG. 10 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework through which generative artificial intelligence-enabled systems are implemented to provide real-time intent analysis and resolution. In response to user queries communicated by different users, the user queries are converted into different sets of embeddings that are evaluated according to different data sources made available through a RAG processor. Based on these different data sources and the different sets of embeddings, the RAG processor and one or more LLMs and/or generative artificial intelligence processes dynamically generate relevant responses to these different user queries.

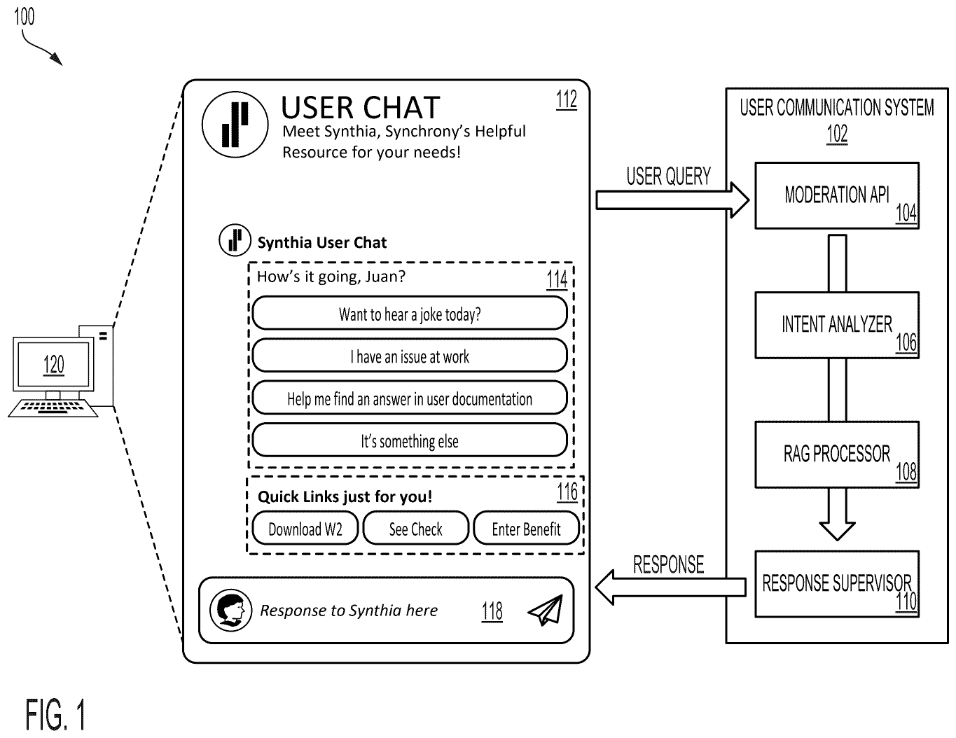

FIG. 1 shows an illustrative example of an environment 100 in which a user communication system 102, through a RAG processor 108, dynamically processes user queries to generate automated responses to the user queries in accordance with at least one embodiment. In the environment 100, a user 120 transmits a request to a user communication system 102 to initiate a communications session with an automated agent dynamically trained and implemented by the user communication system 102. In an embodiment, the user communication system 102 provides, to users (e.g., user 120, etc.) associated with the user communication system 102, an application or web service through which these users may engage in different communications sessions with automated agents to address different intents expressed by these users. An intent may (for example) be a topic, sentiment, complexity, and/or level of urgency. A topic can include, but is not limited to, a subject, a product, a service, a technical issue, a use question, a complaint, a request, etc.

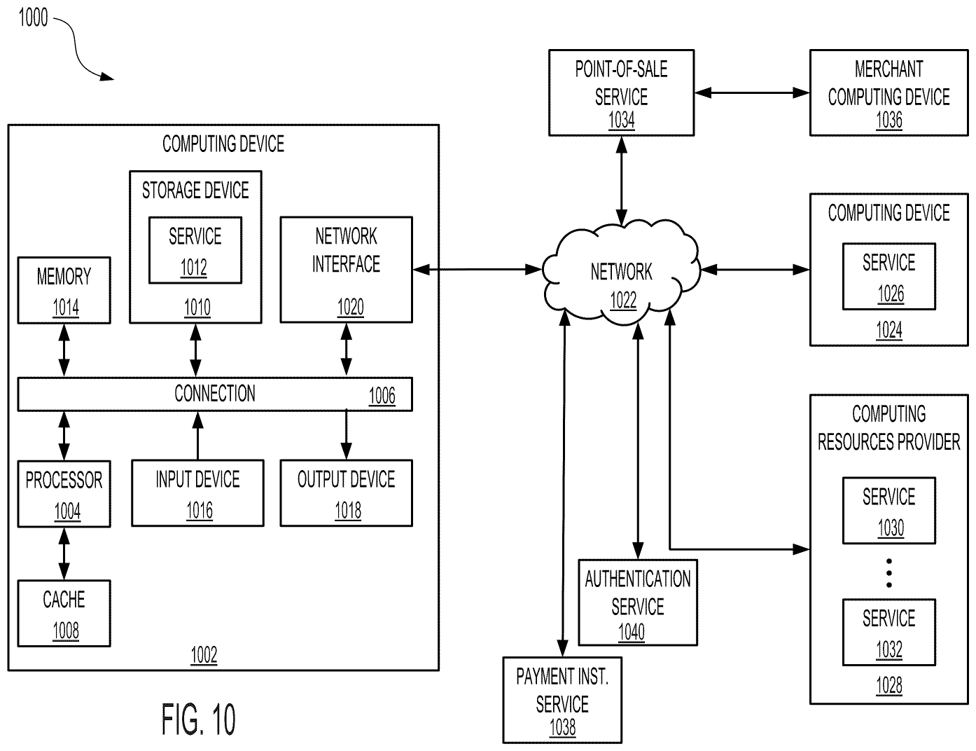

The user communication system 102, in an embodiment, is a system that, for example, processes different user requests through the implementation of automated agents that are dynamically trained to automatically address user intents. Additionally, the user communication system 102, as described in greater detail herein and through different automated processes, may generate customized responses to these user intents according to any applicable constraints (e.g., user roles within an organization, permissible intents, etc.). These customized responses, as described in greater detail herein, may be generated according to known responses maintained by the user communication system 102 and/or to different data sources from which the user communication system 102 may derive these customized responses according to the corresponding intents. In an embodiment, the user communication system 102 may be implemented through a service such as the service 1012 described herein at least in connection with FIG. 10. In an embodiment, the user communication system 102 is implemented through a service provided by a computing resources provider such as the computing resource provide 1028 described herein at least in connection with FIG. 10 (e.g., a service such as service 1030 and/or service 1032 described herein at least in connection with FIG. 10). In an embodiment, the user communication system 102 is implemented by a payment instrument service such as the payment instrument service 1038 described herein at least in connection with FIG. 10. In some instances, the user communication system 102 may be implemented by a service operated by a third-party on behalf of an organization to which the user 120 and other similar users are associated with (e.g., employment, customer relationship, etc.).

In an embodiment, the user communication system 102 provides an application or web service through which users (such as user 120) may access an interface 112 for initiating and engaging in communications sessions with automated agents to address different user intents. For example, the user communication system 102 may provide, to a user 120, an application that may be installed and executed from the user's computing device to access, through the interface 112, the user communication system 102. Additionally, or alternatively, a user 120, through a browser application installed and executed from the user's computing device, may access a website associated with the user communication system 102 and through which the user communication system 102 implements a web service that includes the interface 112. In some instances, to access the interface 112 (either through an application executing on a computing device or through a web service), the user 120 may be required to provide a set of credentials (e.g., username/password, a cryptographic key or token, biometric information, etc.) that may be used to authenticate and identify the user 120. For example, when the user 120 executes the application or accesses the web service to initiate a new communications session through the user communication system 102, the user communication system 102 may prompt the user 120 to provide a set of credentials associated with the user 120.

In response to receiving the set of credentials associated with the user 120, the user communication system 102 may process the set of credentials to determine whether the set of credentials is valid. For instance, in response to receiving a set of credentials through the interface 112, the user communication system 102 may query a user account database (not shown) to determine whether the provided set of credentials is associated with an existing user account maintained by the user communication system 102 or other system/service that is associated with the user communication system 102 (e.g., an organization management system, a human resources system, etc.). If the user communication system 102 determines that the provided set of credentials is not associated with an existing user account, or that the provided set of credentials is not valid (e.g., the set of credentials does not match a known set of credentials maintained in an identified user account, the set of credentials is expired, the set of credentials are flagged as being compromised, etc.), the user communication system 102 may reject the request from the user 120 to initiate a communications session with an automated agent through the interface 112.

If the user communication system 102 determines that the set of credentials is valid or otherwise that the user 120 has been successfully authenticated, the user communication system 102 may update the interface 112 to establish a new communications session between the user 120 and an automated agent. In an embodiment, and as illustrated in FIG. 1, the automated agent automatically surfaces a set of options 114 for initiating engagement with the automated agent according to one or more commonly cited intents. For example, as illustrated in FIG. 1, and for the user 120, the most commonly cited intents that may be relevant to user 120 include an intent related to the presentation of jokes, an intent related to work-related issues, and an intent related to a query resolvable through available user documentation maintained by the user communication system 102 and/or other available resources (e.g., an organization management system, a human resources system, etc.). In some instances, the set of options 114 may further include an option to indicate that the user's intent is related to a topic other than those provided as the most commonly cited intents.

In an embodiment, the user communication system 102 implements and dynamically trains a machine learning algorithm or artificial intelligence to identify a tailored set of options that may be presented to a user upon initiation of a communications session between the user and an automated agent through the interface 112. The machine learning algorithm or artificial intelligence may be dynamically trained in real-time or near real-time using a dataset of sample user data corresponding to a set of sample users (e.g., actual users, hypothetical users, a combination of actual and hypothetical users, etc.), sample conversation data corresponding to the sample users and automated agents (e.g., historical conversation data, hypothetical conversation data, a combination of historical and hypothetical conversation data, etc.), and sample intents associated with the sample conversation data. This dataset may be analyzed using a clustering or classification algorithm to classify the corresponding data according to one or more vectors of similarity between the corresponding data and clusters of intent groupings along different user categories (e.g., user roles, user demographics, etc.). Thus, in some embodiments, the user communication system 102, through the machine learning algorithm or artificial intelligence, can perform such clustering and obtain partial matches among other clusters of intent groupings according to these one or more vectors of similarity to identify a particular cluster and, from this cluster, identify the set of options that are to be presented to a user 120 for a new communications session between the user 120 and an automated agent.

As an illustrative example, the user communication system 102 may dynamically train a clustering algorithm to identify, in response to a new request to initiate a communications session between a user 120 and an automated agent, and based on one or more vectors (e.g., user role, user demographics, etc.) similar users and/or user roles associated with previously conducted communications sessions. These similar users and/or user roles may correspond to different intent groupings based on the one or more vectors.

In an embodiment, the different vectors correspond to input user data identified from available user accounts maintained by the user communication system 102 or other system/service that is associated with the user communication system 102 (e.g., an organization management system, a human resources system, etc.), available historical intents associated with historical communications sessions, and the like. For instance, the one or more vectors may correspond to particular intents extracted from obtained historical communications sessions. Additionally, one or more vectors from the set of vectors may correspond to user or other entity characteristics. For instance, one or more vectors may correspond to demographic information associated with these users including, but not limited to, location (e.g., zip code, etc.), employment history, and the like. In some instances, the one or more vectors may further correspond to different user roles within an organization (e.g., job title, organization responsibilities, etc.). These particular vectors may be associated with clusters corresponding to different intent groupings.

In an embodiment, to dynamically train the machine learning algorithm or artificial intelligence used to identify the initial set of options 114 to be presented to a user upon initiation of a communication session between the user and an automated agent, the user communication system 102 generates an initial iteration of the machine learning algorithm or artificial intelligence. For instance, the user communication system 102 may initialize a set of coefficients {α1, α2, α3, . . . αn} randomly according to a Gaussian distribution with low variance centered around zero or other distribution methods. Using this initial iteration of the machine learning algorithm or artificial intelligence, the user communication system 102 may process the dataset of sample user data corresponding to a set of sample users, sample conversation data corresponding to the sample users and automated agents, and sample intents to generate an output. This output may specify, for each sample set of data corresponding to a sample user included in the dataset, an indication of a set of options that may be presented to the sample user and corresponding to a set of identified intents. The user communication system 102 may compare the output generated using the initial iteration of the machine learning algorithm or artificial intelligence to the sample intents defined in the dataset for each of the data points (e.g., sample user data, sample conversation data corresponding to a sample user, etc.) to identify any inaccuracies or other errors.

If the output of the machine learning algorithm or artificial intelligence does not satisfy one or more criteria, the user communication system 102 may iteratively update one or more coefficients of the set of coefficients to generate an updated machine learning algorithm or artificial intelligence. For instance, the one or more criteria may include a threshold for the accuracy of the desired machine learning algorithm or artificial intelligence for selecting a set of intents for generating the set of options to be presented to a user based on received user and/or user role characteristics. The updated machine learning algorithm or artificial intelligence may be used to process the aforementioned training dataset, as well as any additional data points or other datasets obtained by the user communication system 102 to generate a new output for each data point in the training dataset. In some instances, the user communication system 102 may use an optimization algorithm to iteratively update the one or more coefficients of the set of coefficients associated with the machine learning algorithm or artificial intelligence. For instance, the user communication system 102 may use gradient descent to update the logistic coefficients of the machine learning algorithm or artificial intelligence to generate new cutoff values that may be used to classify the data points of the previously evaluated dataset and of any new data points obtained by the user communication system 102. The user communication system 102 may use this updated machine learning algorithm or artificial intelligence to process the available data points and generate a new output. The user communication system 102 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria.

In an embodiment, if the output generated by the machine learning algorithm or artificial intelligence satisfies the one or more criteria, the user communication system 102 implements the machine learning algorithm or artificial intelligence to dynamically, and in real-time, process user data associated with the different users accessing the user communication system 102 (e.g., user account information, user role, any available historical communication data, etc.) to identify a set of options 114 that may be presented to these different users through the interface 112. In an embodiment, the user communication system 102 uses new communication data and corresponding sets of intents extracted from the communication data as these are obtained through ongoing communications sessions to further retrain or otherwise update the machine learning algorithm or artificial intelligence. For instance, as the machine learning algorithm or artificial intelligence produces, in real-time or near real-time, outputs corresponding to different intent options for different communications sessions, the user communication system 102 or other evaluator of the machine learning algorithm or artificial intelligence may evaluate the output to determine whether the machine learning algorithm or artificial intelligence is generating appropriate intent options for presentation to users through the interface 112. This evaluation may result in additional annotated data points that may be used to retrain or otherwise update the machine learning algorithm or artificial intelligence in real-time or near real-time. For instance, if the machine learning algorithm or artificial intelligence generates a set of options 114 corresponding to a set of intents, and the set of intents are not associated with the user's defined role within an associated organization (e.g., the user 120 is not authorized to engage in communications associated with the intents, the intents are irrelevant to the user 120, etc.), the identified set of options 114 for the user 120 may be annotated to indicate that the machine learning algorithm or artificial intelligence has erroneously generated a set of options 114 that should not have been presented to the user 120. Additionally, in some instances, the subsequent communications data (e.g., conversation between the user 120 and the automated agent) may be annotated with the actual intents extracted from the communication data and from which the set of options 114 should have been generated. These annotated data points may be added to the training dataset, which may be used to dynamically retrain or otherwise update the machine learning algorithm or artificial intelligence using the process described above.

In an embodiment, clustering algorithms are trained using sample datasets of sample user data corresponding to a set of sample users, sample conversation data corresponding to the sample users and automated agents, and sample intents associated with the sample conversation data in order to identify the set of options that may be presented to a user when the user submits a request to the user communication system 102 to initiate a new communications session with an automated agent. Examples of such clustering algorithms may include, but are not limited to, k-means clustering algorithms, fuzzy c-means (FCM) algorithms, expectation-maximization (EM) algorithms, hierarchical clustering algorithms, density-based spatial clustering of applications with noise (DBSCAN) algorithms, and the like.

It should be noted that the user communication system 102, through the machine learning algorithm or artificial intelligence, can continuously and simultaneously process user data associated with different users as corresponding requests to initiate new communications sessions and submitted by these different users are received. For instance, as the user communication system 102 receives or otherwise obtains different user data corresponding to different users, the user communication system 102 may continuously input the different user data into the machine learning algorithm or artificial intelligence for real-time processing. As these different requests corresponding user data is received, the machine learning algorithm or artificial intelligence implemented and dynamically trained by the user communication system 102 may continuously and simultaneously process the different user data associated with these different users to identify, for each user, what set of intent options are to be presented to the user through the interface 112. In some instances, the user communication system 102 may be configured with various special-purpose components that can facilitate real-time or near real-time processing of different user requests and corresponding user data as these different requests are received from any number of different users. Further, these various special-purpose components may be configured to automatically and in real-time or near real-time generate a set of options corresponding to different intents through the aforementioned machine learning algorithm or artificial intelligence.

The machine learning algorithm or artificial intelligence trained to dynamically generate different options corresponding to different intents that may be of interest to users accessing the user communication system 102 provides various computational benefits for the user communication system 102. For instance, by generating a tailored set of options 114 that may be of interest to a user 120 accessing the user communication system 102, the machine learning algorithm or artificial intelligence may reduce the number of communications that may be required of the user 120 to express their intent and, accordingly, solicit a response to their intent. This, in turn, may reduce the processing requirements of the user communication system 102 as the volume of individual communications that need to be processed in order to determine each user's expressed intent is reduced.

In an embodiment, in addition to generating a set of options 114 corresponding to different intents that may be of interest to the user 120 and/or that the user 120 and/or similar users express during communications sessions with automated agents, the user communication system 102, through the interface 112, can further surface a set of links 116 corresponding to different resources that may be used to address a user's intent. The set of links 116 presented to the user 120 may be identified by the aforementioned machine learning algorithm or artificial intelligence. For instance, based on the user data associated with the user 120 and any historical communications data corresponding to previous communications sessions between the user 120 and one or more automated agents and to intents expressed by the user 120, the machine learning algorithm or artificial intelligence may identify a set of intents that may be of interest to the user 120. Based on the identified set of intents, the user communication system 102 may identify a set of resources that may be presented to the user 120 to address this identified set of intents. For example, if the machine learning algorithm or artificial intelligence produces, as output, an indication that the user 120 may be interested in evaluating their wage and tax information, the user communication system 102 may dynamically generate a set of links that, if selected, may direct the user 120 to their W-2 statement or to their recent pay statement. As another illustrative example, if the machine learning algorithm or artificial intelligence produces, as output, an indication that the user 120 is routinely interested in reviewing their available benefits, the user communication system 102 may dynamically generate a link to a resource through which the user 120 may review their benefits package as provided by their organization or other entity. By providing this set of links 116 to the user 120 corresponding to different intents identified as being of interest to the user 120, the machine learning algorithm or artificial intelligence further reduce the number of communications that may be required of the user 120 to express their intent and, accordingly, solicit a response to their intent. This may further reduce the processing requirements of the user communication system 102.

As illustrated in FIG. 1, the interface 112 may further include an input field 118 through which a user 120 may transmit a communication to the automated agent assigned to the communications session. In an embodiment, as the user 120 submits a communication or message to the automated agent through the input field 118, the interface 112 may be automatically updated to present the communication or message submitted by the user 120. Additionally, this communication or message may be transmitted, in real-time or near real-time, to a moderation application programming interface (API) 104 implemented by the user communication system 102 for initial screening of the communication or message. Through the moderation API 104, the user communication system 102 may evaluate the received communication or message to determine whether the communication or message comports with any applicable rules for eligible queries. For instance, in response to a new communication or message from a user 120, the moderation API 104 may apply natural language processing (NLP) or any other text parsing algorithm or executable code to automatically parse the new communication or message. Through this parsing of the new communication or message, the moderation API 104 may identify particular terms that may be used to determine a user intent expressed by the user 120.

In an embodiment, the user communication system 102, through the moderation API 104, determines whether the user intent expressed in the communication or message comports with a set of applicable rules corresponding to permissible communications or intents. The set of applicable rules may specify what intents may be processed by the user communication system 102 as well as any actions that are to be performed in the event that a user submits an impermissible communication or message through the interface 112. For example, if the communication or message submitted by the user 120 includes a query as to who won the World Series in 2004, the user communication system 102, through the moderation API 104, may determine that the user's intent (e.g., baseball-related statistics) is not associated with any permissible intents as defined through the set of applicable rules. Accordingly, the moderation API 104 may reject the user communication or message as being irrelevant to the purpose of the user communication system 102. Accordingly, the user communication system 102, through the moderation API 104, may cause the automated agent to transmit a response to the user 120 to indicate that the submitted communication or message could not be processed. In some instances, the automated agent may automatically generate a response that admonishes the user 120 for submitting an impermissible communication or message to the automated agent through the interface 112. In some instances, the automated agent may automatically terminate the communication session in response to the impermissible communication or message and the corresponding indication from the moderation API 104.

In some instances, the moderation API 104 may restrict user access to the user communication system 102 in the event that the user 120 submits an impermissible communication or message to the automated agent. For example, the moderation API 104 may add one or more restrictions to the user's account to prevent the user from accessing the user communication system 102 for a period of time (e.g., one day, one week, one month, etc.). Further, these one or more restrictions may be defined according to the severity of the user's violation of any applicable rules. As an illustrative example, if the user 120 submits a request for personnel data that the user 120 is not authorized to access and that is highly sensitive, the moderation API 104 may automatically impose a more severe restriction (e.g., a longer temporal restriction, an outright ban from the user communication system 102, etc.) on the user 120. In some instances, the restrictions that are applied in response to an impermissible communication or message may be defined in the set of applicable rules.

The moderation API 104 implemented by the user communication system 102 may provide various computational benefits to the functioning of the user communication system 102. For instance, because the moderation API 104 is configured to automatically reject any user communications that do not comport with any applicable rules, the user communication system 102 does not have to process these user communications further, thereby reducing the processing requirements of the user communication system 102 in generating responses to these impermissible user communications. Further, the moderation API 104 increases the network security of the user communication system 102 by automatically rejecting any communications that are not associated with permissible intents, preventing generation of responses that may include sensitive data or other data that the corresponding user may not be authorized to obtain.

In an embodiment, if the user communication or message submitted through the input field 118 comports with the set of applicable rules implemented through the moderation API 104, the user communication system 102 may process the user communication or message through an intent analyzer 106 to determine whether the expressed intent may be processed using one or more known responses or requires additional processing to generate a new and tailored appropriate response. The intent analyzer 106 may comprise one or more computer systems of the user communication system 102 or may be implemented as an application or process executing on a computer system of the user communication system 102. In some instances, the intent analyzer 106 may be configured with various special-purpose components that can facilitate real-time or near real-time processing of different user communications or messages from any number of different users as these different user communications or messages are received.

In an embodiment, the intent analyzer 106 implements and dynamically trains a machine learning algorithm or artificial intelligence to process incoming user communications or messages to identify user intents and, based on these user intents, determine whether the user intents may be addressed using one or more known responses or require additional processing. The machine learning algorithm or artificial intelligence may be dynamically trained using supervised, unsupervised, or hybrid training techniques. For instance, a dataset of sample user communications (e.g., known or historical user communications, sample user communications, combinations of known/historical and hypothetical user communications, etc.), sample intents, and sample responses (e.g., known responses corresponding to previously detected intents by the intent analyzer 106 or otherwise recorded by the user communication system 102, etc.) may be analyzed using a clustering or classification algorithm to classify the sample user communications according to a set of different classifications (e.g., intents and corresponding responses). For instance, the machine learning algorithm may be dynamically trained in real-time by converting the sample user communications or messages into a set of communication embeddings and the sample responses into a set of response embeddings. The machine learning algorithm or artificial intelligence may classify the sample user communications or messages according to one or more vectors of similarity between the set of communication embeddings and the set of response embeddings. In some instances, the machine learning algorithm or artificial intelligence may be implemented with a threshold that may be used to determine, based on the aforementioned embeddings and the one or more vectors of similarity, whether a sample user communication or message is sufficiently similar (e.g., satisfies the threshold by having a requisite amount of embeddings being within a level of tolerance of corresponding response embeddings for a particular known response) to a particular sample response. If a sample user communication or message does not satisfy the required threshold for classification to a particular known response, the machine learning algorithm or artificial intelligence may be trained to transfer the sample user communication or message to a Retrieval Augmented Generation (RAG) processor 108 for generation of a tailored response to the sample communication or message, as described in greater detail herein.

In an embodiment, through the machine learning algorithm or artificial intelligence, the intent analyzer 106 may perform such clustering or classification of different user communications or messages in real-time or near real-time as these communications or messages are generated by a user. Through this processing of the different user communications or messages, the intent analyzer 106 may obtain partial matches among different known responses to identify the appropriate action to be performed (e.g., provide a known response to the communication). Further, if evaluation of embeddings of a particular communication or message fail to satisfy the aforementioned threshold for identification of an existing known response that may be used to address the user's intent, the machine learning algorithm or artificial intelligence may automatically transfer the user communication or message to the RAG processor 108 for further processing and generation of a tailored response to the user's intent. Example classification and/or clustering algorithms that may be implemented include Support Vector Machines (SVM), k-Nearest Neighbor (KNN) algorithms, logistic regression algorithm, random forest models, Naïve Bayes models, linear regression models, decision tree models, gradient boosting machine models, and the like.

In an embodiment, as new user communications or messages are received and that have passed through the moderation API 104, the machine learning algorithm or artificial intelligence implemented by the intent analyzer 106 may convert the communications or messages into corresponding embeddings and accordingly perform such clustering or classification of the embeddings to obtain partial matches among other clusters or classifications according to the one or more vectors of similarity. Through this process, the machine learning algorithm or artificial intelligence may identify, for each new user communication or message received, a particular cluster or class and, from this cluster or class, identify a response that may be provided through the interface 112 or other action (e.g., transfer to a RAG processor 108) that may be performed in response to the user communication or message. In some instances, as feedback is received with regard to any responses generated by the intent analyzer 106 and provided in response to received user communications or messages, the machine learning algorithm or artificial intelligence may be dynamically updated to better provide relevant responses to similar user communications or messages.

In an embodiment, the intent analyzer 106 maintains a database or other datastore within which any known responses to previous user queries and other commonly submitted questions are stored. These known responses may be generated by the user communication system 102 or other entity associated with the user communication system 102 based on different available resources. For instance, if the user communication system 102 or other organization associated with the user communication system 102 maintains one or more documents that include answers to frequently asked questions (FAQ), the intent analyzer 106 may process these one or more documents to extract the known responses to these frequently asked questions for inclusion in the database or other datastore. In some instances, these frequently asked questions and corresponding known responses may be converted by the intent analyzer 106 into different sets of embeddings through the aforementioned processes. This may allow the intent analyzer 106 to compare the embeddings corresponding to a received communication or message to these different sets of embeddings to determine whether the received communication or message may be resolved using a known response maintained in the database or other datastore. By maintaining a database or other datastore that contains known responses to previous user queries and other commonly submitted questions, the user communication system 102, through the intent analyzer 106, may rapidly provide responses to user queries for which a known response is available. This may reduce the processing time and resources required by the user communication system 102 in providing responses to user queries, as these resources may be maintained for more complex user queries that may require additional processing in order to generate a response. Further, as responses are generated for these more complex user queries, these responses may be stored within this database or other datastore and made available in response to similar user queries. This may prevent duplicative processing of user queries and different resources (such as through the RAG processor 108 described herein) to generate responses to these user queries.

In an embodiment, if the intent analyzer 106 determines that the submitted communication or message cannot be resolved using a known response maintained by the intent analyzer 106, the intent analyzer 106 automatically transmits this communication or message to a RAG processor 108 for further processing and generation of a response. The RAG processor 108 may comprise one or more computer systems of the user communication system 102 or may be implemented as an application or process executing on a computer system of the user communication system 102. In some instances, the RAG processor 108 may be configured with various special-purpose components that can facilitate real-time or near real-time processing of different user communications or messages from any number of different users as these different user communications or messages are received.

In an embodiment, the RAG processor 108 is implemented in conjunction with one or more large language models (LLM) and/or other generative artificial intelligence processes that are dynamically trained to generate responses to user queries (e.g., communications or messages submitted through the interface 112, etc.) based on evaluation of myriad data sources available to the RAG processor 108. For instance, the RAG processor 108 may maintain a knowledge base repository or other datastore that is associated with myriad external and/or internal data sources made available to the user communication system 102 for generating responses to any user communications or messages. In an embodiment, the RAG processor 108, through this knowledge base repository or other datastore, maintains different embeddings corresponding to different internal and external data sources made available to the RAG processor 108 for generating responses to received communications or messages. For instance, if the RAG processor 108 is provided with access to one or more external human resource systems maintained by an organization that implements the user communication system 102, the RAG processor 108 may automatically access or scrape any available data sources within these one or more external human resource systems and, accordingly, convert the data includes in these data sources into different sets of embeddings that may be used to dynamically generate responses to received communications or messages. The RAG processor 108 may be granted access to a significant number of internal and/or external data sources (e.g., private/organization-based data sources, publicly available data sources, etc.) such that the knowledge base repository or other datastore maintained by the RAG processor 108 may include embeddings corresponding to millions or billions of different data sources. Thus, the RAG processor 108, in some embodiments, is implemented using thousands, tens of thousands, or more processors that are configured to operate in parallel to access any available data sources and generate corresponding embeddings.

The one or more LLMs and/or other generative artificial intelligence processes implemented by the RAG processor 108 are, in an embodiment, dynamically trained using a dataset comprising a large corpus of sample communications/messages (e.g., historical communications/messages, hypothetical communications/messages, combinations of historical and hypothetical communications/messages, etc.), sample embeddings corresponding to the sample communications/messages, and sample responses to the sample communications/messages (e.g., historical responses, hypothetical responses, combinations of historical and hypothetical responses, etc.). The one or more LLMs and/or other generative artificial intelligence processes may be initialized with a first set of values corresponding to different hyperparameters or other coefficients that, in combination, are used to derive an output given a sample input (e.g., sample communications/messages). For instance, the RAG processor 108 may initialize a set of coefficients or other hyperparameters randomly according to a Gaussian distribution with low variance centered around zero or through other distribution methods. Using this initial iteration of the one or more LLMs or other generative artificial intelligence processes, the RAG processor 108 may process the dataset of sample communications/messages to generate an output. This output may specify, for each sample communication or message, a response to the communication or message. The one or more LLMs or other generative artificial intelligence processes may compare the output (e.g., predicted responses) to the expected responses included in the dataset. Based on this comparison, the one or more LLMs or other generative artificial intelligence processes may dynamically update the values corresponding to the different hyperparameters or other coefficients and again process the dataset to generate new outputs. This process may be repeated numerous times until an iteration of the one or more LLMs or other generative artificial intelligence processes is obtained that satisfies one or more accuracy or predictability thresholds.

In an embodiment, the one or more LLMs or other generative artificial intelligence processes are further trained in conjunction with RAG to improve the predictability of the one or more LLMs or other generative artificial intelligence processes in generating responses that accurately resolve the intents expressed in received communications or messages. For instance, in addition to evaluating the one or more LLMs or other generative artificial intelligence processes according to linguistic metrics (e.g., Bilingual Evaluation Understudy (BLEU) scores, language fluency metrics, semantic consistency metrics, etc.), the RAG processor 108 may determine whether the one or more LLMs or other generative artificial intelligence processes are accurately leveraging the available knowledge bases generated using the aforementioned internal and external data sources to generate outputs (e.g., responses) that address the sample intents expressed in the sample communications/messages. For instance, the RAG processor 108 may evaluate the output generated by the one or more LLMs or other generative artificial intelligence processes to determine whether the one or more LLMs or other generative artificial intelligence processes are correctly converting the sample communications/messages into a set of embeddings and identifying appropriate data sources from the knowledge bases according to this set of embeddings (e.g., correctly matching the set of embeddings to knowledge base embeddings corresponding to data sources usable to address the underlying intents, etc.). Based on this evaluation, the RAG processor 108 may dynamically update the one or more LLMs or other generative artificial intelligence processes as described above to improve the responses generated by these one or more LLMs or other generative artificial intelligence processes.

In response to a communication or message submitted by the user 120 and provided by the intent analyzer 106, the RAG processor 108, through the one or more LLMs or other generative artificial intelligence processes, may dynamically generate a response that is derived from the one or more knowledge bases maintained by the RAG processor 108 and generated from various internal and external data sources. In an embodiment, prior to the newly generated response being communicated to the user 120 through the interface 112, the response may be processed through a response supervisor 110 to ensure that the response comports with any applicable rules and other controls. The response supervisor 110 may comprise one or more computer systems of the user communication system 102 or may be implemented as an application or process executing on a computer system of the user communication system 102. In some instances, the response supervisor 110 may be configured with various special-purpose components that can facilitate real-time or near real-time processing of different responses generated by the RAG processor 108 as these different responses are received.

In response to receiving a proposed response message from the RAG processor 108, the response supervisor 110 may evaluate the proposed response message, as well as any information associated with the user 120, to determine whether the proposed response message may be communicated to the user 120 through the interface 112. As noted above, in some instances, the user communication system 102, in response to a user request to initiate a communications session with an automated agent, may assess the user's role within an organization or other entity to identify the permissible intents that may be communicated by the user 120. As an illustrative example, if the user 120 is an employee that is not authorized to access payroll data associated with the organization (e.g., the user's role is not associated with payroll functions, etc.), the user communication system 102 may prohibit the user 120 from submitting a query corresponding to these impermissible payroll functions. In an embodiment, the response supervisor 110 may similarly evaluate a proposed response message to determine whether the proposed response message includes any information or other data that the user 120, based on their defined role, is not authorized to access. If the proposed response message includes impermissible information or other data, the response supervisor 110 may reject the proposed response message. This rejection of the proposed response message may serve as feedback that may be used to dynamically retrain the one or more LLMs or other generative artificial intelligence processes implemented by the RAG processor 108. Thus, the response supervisor 110 improves the network security of the user communication system 102 by preventing dissemination of sensitive data or other data that users may not be authorized to access.

As another illustrative example, the response supervisor 110 may evaluate a proposed response message according to different linguistic metrics (e.g., BLEU scores, language fluency metrics, semantic consistency metrics, etc.) to determine whether the proposed response message is likely to be understood by the user 120. The response supervisor 110 may maintain, for each of these different linguistic metrics, a set of thresholds that may need to be satisfied in order for the proposed response message to be accepted by the response supervisor 110 and transmitted to the user 120 through the interface 112. If the proposed response message fails any of these evaluations according to the set of thresholds, the response supervisor 110 may reject the proposed response message and provide feedback to the RAG processor 108 that may be used to dynamically retrain the one or more LLMs or other generative artificial intelligence processes implemented by the RAG processor 108.

If the response supervisor 110 determines that the proposed response message from the RAG processor 108 is acceptable, the response supervisor 110, through the automated agent, may provide the response message to the user 120 through the interface 112. As the user 120 interacts with the response message (e.g., submits their own responses to the response message, submits new user queries, etc.), the user communication system 102 may dynamically process these interactions through the aforementioned components to generate new response messages and to dynamically retrain any of the aforementioned machine learning algorithms or artificial intelligence processes to provide improved responses to user communications and messages.

It should be noted that the user communication system 102, through the aforementioned machine learning algorithms or artificial intelligence, can continuously and simultaneously process different user communications and messages corresponding to different communications sessions and generate responses to these different user communications and messages. For instance, as different user communications and messages associated with different users are received, the user communication system 102, through the aforementioned machine learning algorithms or artificial intelligence implemented by the intent analyzer 106 and the RAG processor 108, may continuously process these different user communications and messages in real-time or near real-time to extract the corresponding intents and, based on these intents and available user data (e.g., roles, etc.), generate relevant responses that may be provided to these different users.

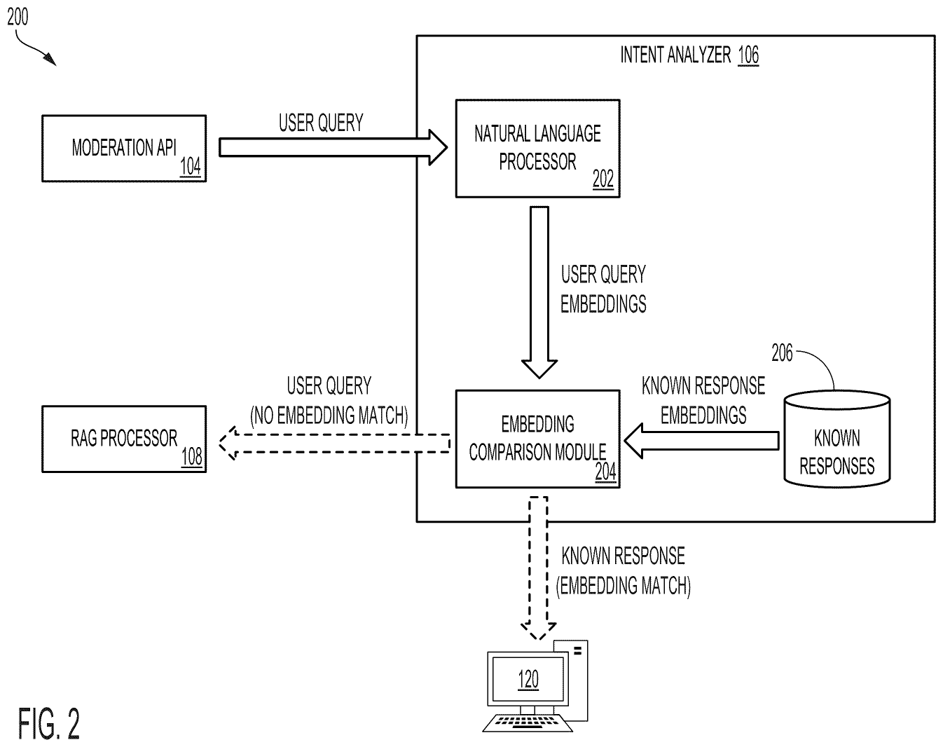

FIG. 2 shows an illustrative example of an environment 200 in which an intent analyzer 106 dynamically processes a user query to generate a set of embeddings and to evaluate the set of embeddings according to known responses in accordance with at least one embodiment. In the environment 200, the intent analyzer 106 implements a Natural Language Processor (NLP) 202 that is dynamically trained to process user communications or messages obtained through the moderation API 104 to convert these user communications or messages into sets of message embeddings. The NLP 202 may be dynamically trained using a dataset of sample communications/messages (e.g., historical communications/messages, hypothetical communications/messages, combinations of historical and hypothetical communications/messages, etc.) and sample embeddings corresponding to the sample communications/messages. To dynamically train the NLP 202, the intent analyzer 106 may generate an initial iteration of the NLP 202. For instance, the intent analyzer 106 may initialize a set of coefficients or hyperparameters randomly according to a Gaussian distribution with low variance centered around zero or other distribution methods. Using this initial iteration of the NLP 202, the intent analyzer 106 may process the dataset of sample communications/messages and corresponding embeddings to generate an output. This output may specify, for each sample communication/message included in the dataset, a predicted set of embeddings. The intent analyzer 106 may compare the predicted set of embeddings generated using the initial iteration of the NLP 202 to the sample embeddings defined in the dataset for each of the data points (e.g., sample communications/messages) to identify any inaccuracies or other errors.

If the output of the NLP 202 does not satisfy one or more criteria, the intent analyzer 106 may iteratively update one or more coefficients of the set of coefficients to generate a new iteration of the NLP 202. This new iteration of the NLP 202 may be used to process the aforementioned training dataset, as well as any additional data points or other datasets obtained by the user communication system 102 to generate a new output for each data point in the training dataset. In some instances, the intent analyzer 106 may use an optimization algorithm to iteratively update the one or more coefficients of the set of coefficients associated with the NLP 202. The intent analyzer 106 may use this new iteration of the NLP 202 to process the available data points and generate a new output. The intent analyzer 106 may evaluate this new output to determine whether the output satisfies the one or more criteria. This process of updating the set of coefficients associated with the NLP 202 according to the one or more criteria may be performed iteratively until an iteration of the NLP 202 is produced that satisfies the one or more criteria.

Once the NLP 202 is dynamically trained to convert received user communications and messages into different sets of embeddings, the NLP 202 may process the user communication or message received through the moderation API 104 into a particular set of embeddings corresponding to the user communication or message. The NLP 202 may transmit this set of embeddings to an embedding comparison module 204 of the intent analyzer 106 to determine whether the user communication or message may be resolved using a known response. The embedding comparison module 204, in an embodiment, implements a machine learning algorithm or artificial intelligence that is dynamically trained to compare received sets of embeddings to embeddings corresponding to known responses, as described above in connection with FIG. 1. The embeddings corresponding to known responses may be maintained in a known responses datastore 206. These known responses may be generated by the user communication system or other entity associated with the user communication system based on different available resources. For instance, if the user communication system or other organization associated with the user communication system maintains one or more documents that include answers to frequently asked questions, the intent analyzer may process these one or more documents to extract the known responses to these frequently asked questions for inclusion in the known responses datastore 206. In some instances, these frequently asked questions and corresponding known responses may be converted by the intent analyzer 106 into different sets of embeddings through the aforementioned processes.

Through the machine learning algorithm or artificial intelligence, the embedding comparison module 204 may perform clustering or classification of different user communications or messages in real-time or near real-time as these communications or messages are generated by a user. Through this processing of the different user communications or messages, the embedding comparison module 204 may obtain partial matches among different known responses to identify the appropriate action to be performed (e.g., provide a known response to the communication). Further, if evaluation of embeddings of a particular communication or message fail to satisfy the aforementioned threshold for identification of an existing known response that may be used to address the user's intent, the embedding comparison module 204 may automatically transfer the user communication or message to the RAG processor 108 for further processing and generation of a tailored response to the user's intent. If the embedding comparison module 204 determines that the set of embeddings corresponding to a received communication or message sufficiently matches a set of response embeddings corresponding to a known response from the known responses datastore 206 (e.g., the partial matches satisfy the aforementioned threshold, etc.), the embedding comparison module 204 may provide the known response to the user 120 through the aforementioned interface.

By identifying known responses from the known responses datastore 206 for matching user queries, the embedding comparison module 204 may improve the functioning and efficiency of the intent analyzer 106 in processing user queries. For instance, if a known response is available for an obtained user query, the embedding comparison module 204 may provide this known response to the user 120 as opposed to transmitting the user query to the RAG processor 108 for further processing and tailored generation of a response to the user query. This may preserve computing resources allocated to the RAG processor 108 for more complex user queries for which a known response may not be available. Further, as the RAG processor 108 generates responses to these complex user queries, these responses may be added to the known responses datastore 206 such that if a similar user query is received by the embedding comparison module 204, the embedding comparison module 204 may more readily identify and provide a previously generated response rather than transmitting this similar user query to the RAG processor 108. This results in a reduction of duplicative computational processing of these similar user queries, thereby improving the efficiency and functioning of the computer systems used to implement the intent analyzer 106, the RAG processor 108, and the user communication system as a whole.

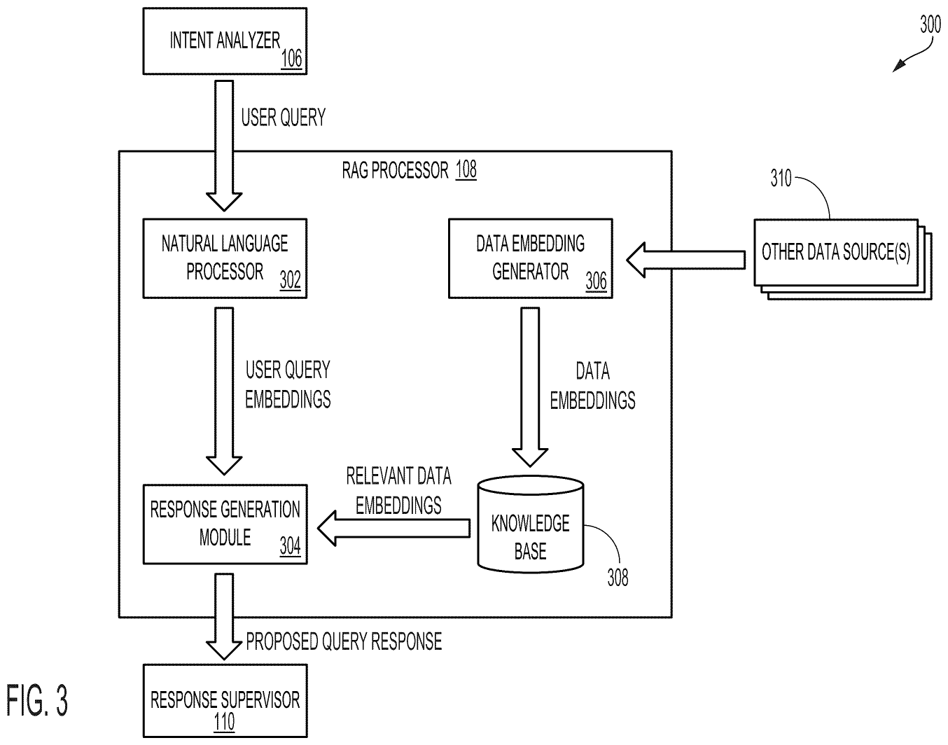

FIG. 3 shows an illustrative example of an environment 300 in which a RAG processor 108 dynamically processes a set of user query embeddings to identify different relevant data embeddings for generation of a relevant response to the user query in accordance with at least one embodiment. In the environment 300, the RAG processor 108 dynamically processes a user communication or message obtained from an intent analyzer 106 through a NLP 302 to generate a set of embeddings corresponding to the user communication or message. The NLP 302 may be similar to the NLP 202 described above in connection with FIG. 2. The NLP 302 may transmit this set of embeddings to a response generation module 304 for generation of a tailored response to the user communication or message.

The response generation module 304, in an embodiment, implements one or more LLMs and/or other generative artificial intelligence processes that are supplemented using RAG to generate responses to user communications or messages as these user communications or messages are received. As noted above, the RAG processor 108 may maintain a knowledge base repository 308 that is associated with myriad external and/or internal data sources 310 made available to the user communication system for generating responses to any user communications or messages. In an embodiment, the RAG processor 108 implements a data embedding generator 306 that is configured to access the myriad external and/or internal data sources 310 to obtain any available data and to convert this available data into different sets of data embeddings that may be used to supplement the knowledge base repository 308. The data embedding generator 306 may implement a machine learning algorithm or artificial intelligence that is dynamically trained to perform such conversions of data into different sets of data embeddings. This machine learning algorithm or artificial intelligence may be dynamically trained according to any of the methods described above for machine learning algorithms or artificial intelligence implemented to generate sets of embeddings for user communications/messages and known responses.

As described in an earlier illustrative example, if the RAG processor 108 is provided with access to one or more external human resource systems maintained by an organization that implements the user communication system, the RAG processor 108, through the data embedding generator 306, may automatically access or scrape any available data sources within these one or more external human resource systems and, accordingly, convert the data included in these data sources into different sets of embeddings that may be used to dynamically generate responses to received communications or messages. The RAG processor 108 may be granted access to a significant number of internal and/or external data sources 310 (e.g., private/organization-based data sources, publicly available data sources, etc.) such that the knowledge base repository 308 maintained by the RAG processor 108 may include embeddings corresponding to millions or billions of different data sources. Thus, the RAG processor 108 and its various components (as illustrated in FIG. 3), in some embodiments, are implemented using thousands, tens of thousands, or more processors that are configured to operate in parallel to access any available data sources 310 and generate corresponding embeddings.

The one or more LLMs or other generative artificial intelligence processes implemented by the response generation module 304 are trained in conjunction with RAG to improve the predictability of the one or more LLMs or other generative artificial intelligence processes in generating responses that accurately resolve the intents expressed in received communications or messages. For instance, in addition to evaluating the one or more LLMs or other generative artificial intelligence processes according to linguistic metrics, the RAG processor 108 may determine whether the one or more LLMs or other generative artificial intelligence processes are accurately leveraging the knowledge base repository 308. For instance, the RAG processor 108 may evaluate the output generated by the response generation module 304 to determine whether the one or more LLMs or other generative artificial intelligence processes are identifying appropriate data sources from the knowledge base repository 308 according to the generated set of embeddings (e.g., correctly matching the set of embeddings to knowledge base embeddings corresponding to data sources usable to address the underlying intents, etc.). Based on this evaluation, the RAG processor 108 may dynamically update the one or more LLMs or other generative artificial intelligence processes as described above to improve the responses generated by these one or more LLMs or other generative artificial intelligence processes.

In response to a set of embeddings from the NLP 302, the response generation module 304, through the one or more LLMs or other generative artificial intelligence processes and leveraging the knowledge base repository 308, may dynamically generate a response that is derived from the knowledge base repository 308. As noted above, prior to the newly generated response being communicated to the user, the response may be processed through a response supervisor 110 to ensure that the response comports with any applicable rules and other controls. Accordingly, the response generation module 304 may transmit the proposed response to the user communication or message to the response supervisor 110 for additional processing prior to providing the response to the user.

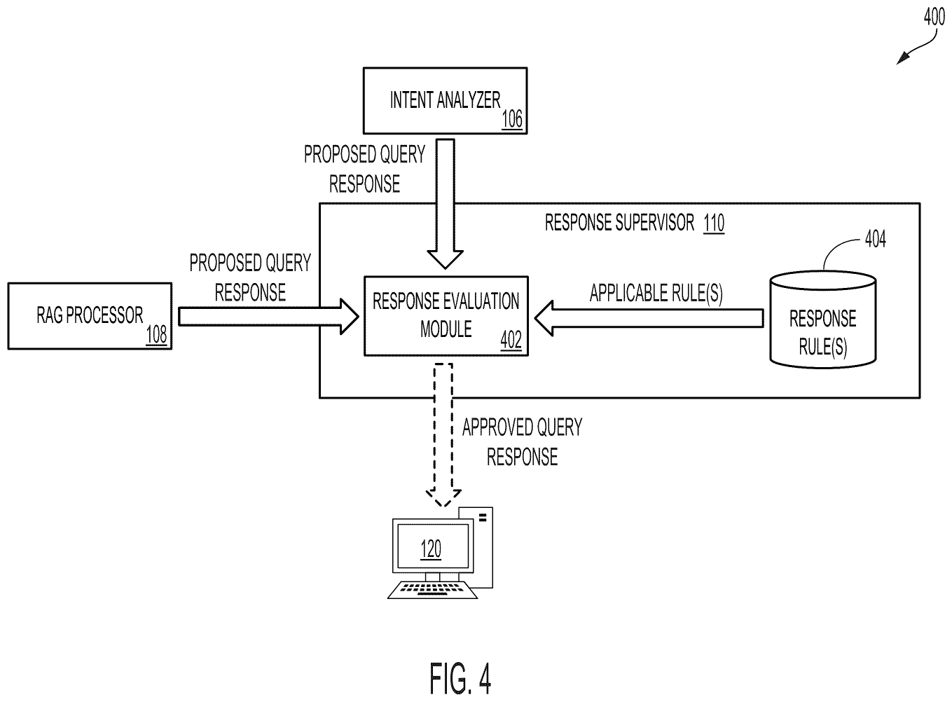

FIG. 4 shows an illustrative example of an environment 400 in which a response supervisor 110 evaluates a proposed user query response generated by the intent analyzer 106 or RAG processor 108 to determine whether the user query response can be provided to a user 120 in accordance with at least one embodiment. In the environment 400, the response supervisor 110, through a response evaluation module 402, may receive a proposed response to a user communication or message. The proposed response, as noted above, may be dynamically generated by the RAG processor 108 according to available data sources and processing of embeddings corresponding to these available data sources and to the original user communication or message. Alternatively, the proposed response may be dynamically generated by the intent analyzer 106 according to available known responses associated with the submitted user communication or message.

In response to the proposed response from the intent analyzer 106 or RAG processor 108, the response evaluation module 402 may evaluate the proposed response message, as well as any information associated with the user 120, to determine whether the proposed response message may be communicated to the user 120. As noted above, in some instances, the user communication system, in response to a user request to initiate a communications session with an automated agent, may assess the user's role within an organization or other entity to identify the permissible intents that may be communicated by the user. In an embodiment, the response evaluation module 402 may similarly evaluate a proposed response message to determine whether the proposed response message includes any information or other data that the user 120, based on their defined role, is not authorized to access. If the proposed response message includes impermissible information or other data, the response evaluation module 402 may reject the proposed response message. This rejection of the proposed response message may serve as feedback that may be used to dynamically retrain the one or more LLMs or other generative artificial intelligence processes implemented by the RAG processor 108. If the response was generated by the intent analyzer 106, the rejection of the proposed response message may serve as feedback that may be used to dynamically retrain the machine learning algorithm or artificial intelligence implemented by the embedding comparison module (such as the embedding comparison module 204 described above in connection with FIG. 2) to generate responses to user queries for which known responses are available.

As another illustrative example, the response evaluation module 402 may evaluate a proposed response message according to different linguistic metrics (e.g., BLEU scores, language fluency metrics, semantic consistency metrics, etc.) to determine whether the proposed response message is likely to be understood by the user 120. The response evaluation module 402 may maintain, for each of these different linguistic metrics, a set of thresholds that may need to be satisfied in order for the proposed response message to be accepted by the response evaluation module 402 and transmitted to the user 120. If the proposed response message fails any of these evaluations according to the set of thresholds, the response evaluation module 402 may reject the proposed response message and provide feedback to the RAG processor 108 that may be used to dynamically retrain the one or more LLMs or other generative artificial intelligence processes implemented by the RAG processor 108. If the response evaluation module 402 determines that the proposed response message from the intent analyzer 106 or the RAG processor 108 is acceptable, the response evaluation module 402, through the automated agent, may provide the response message to the user 120.

The various rules and other controls relied upon by the response evaluation module 402 (e.g., metrics thresholds, rules associated with different roles, policies, permissions, etc.) may be maintained in a response rules repository 404 maintained by the response supervisor 110. In response to the proposed response message, the response evaluation module 402 may query the response rules repository 404 to obtain any applicable rules and/or other controls that are to be applied to the proposed response message. This query may be structured according to any available user information (e.g., roles, demographics, etc.).

By dynamically evaluating proposed response messages generated by the intent analyzer 106 and the RAG processor 108 for different user communications and messages, the response supervisor 110 improves the network security of the user communication system 102 and of the various data sources used to generate these response messages. For instance, the response evaluation module 402, through evaluation of proposed response messages according to any applicable rules and/or other controls associated with the user 120 and/or the corresponding data itself, the response evaluation module 402 may prevent dissemination of data to the user 120 that the user 120 is not authorized to access.

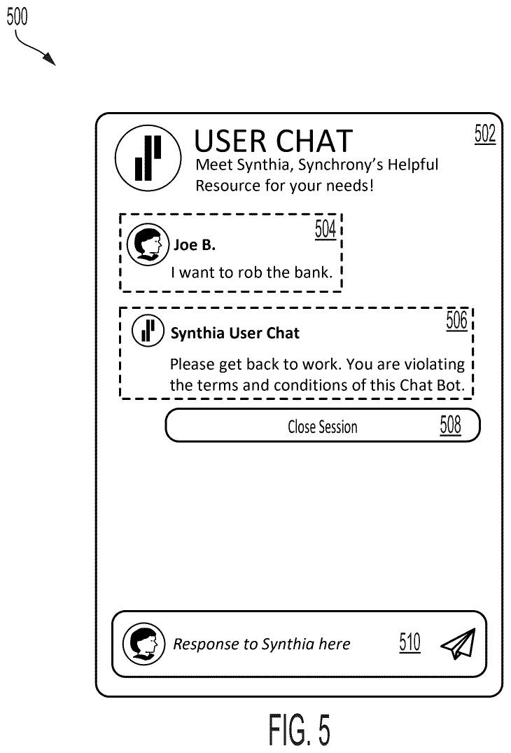

FIG. 5 shows an illustrative example of an environment 500 in which a user communication system detects a user query 504 associated with an impermissible intent and generates a response 506 according to the impermissible intent in accordance with at least one embodiment. In the environment 500, a user may be engaged in a communications session with an automated agent through an interface 502. The interface 502 may be similar to the interface 112 described above in connection with FIG. 1. As illustrated in FIG. 5, the user has transmitted a communication or message (e.g., user query 504) to the automated agent through the interface 502 indicating that they want to rob the bank. This user query 504 may have been submitted by the user in jest and may not correspond to a legitimate use of the interface 502 and the user communication system.

As noted above, when a user submits, through the interface 502, a user query (such as user query 504), this user query may be transmitted, in real-time or near real-time, to a moderation API implemented by the user communication system for initial screening of the user query. Through the moderation API, the user communication system may evaluate the user query to determine whether the user query comports with any applicable rules for eligible queries. For instance, in response to the user query 504, the moderation API may apply NLP or any other text parsing algorithm or executable code to automatically parse the user query 504. Through this parsing of the user query 504, the moderation API may identify particular terms that may be used to determine a user intent expressed by the user. In the example illustrated in FIG. 5, the moderation API may detect the terms or phrases “rob the bank” from the user query 504. These terms or phrases may correspond to an intent associated with an illegal act, which may have been communicated in jest by the user.

In an embodiment, the user communication system, through the moderation API, determines whether the user intent expressed in the communication or message comports with a set of applicable rules corresponding to permissible communications or intents. The set of applicable rules may specify what intents may be processed by the user communication system as well as any actions that are to be performed in the event that a user submits an impermissible communication or message through the interface 502. Returning to the example illustrated in FIG. 5, if the user query 504 submitted by the user includes a statement that the user would like to rob the bank (whether submitted in jest or as a serious statement), the user communication system, through the moderation API, may determine that the user's intent (e.g., robbing the bank) is not associated with any permissible intents as defined through the set of applicable rules. Accordingly, the moderation API may reject the user query 504 as being irrelevant to the purpose of the user communication system. Accordingly, the user communication system, through the moderation API, may cause the automated agent to transmit a response 506 to the user to indicate that the submitted user query 504 could not be processed. In some instances, the automated agent may automatically generate a response 506 that admonishes the user for submitting an impermissible communication or message to the automated agent through the interface. For example, as illustrated in FIG. 5, the automated agent has generated a response 506 instructing the user to get back to work. Further, the response 506 may indicate that the user, through submission of the user query 504, has violated the terms and conditions associated with the use of the interface 502 and in communicating with the automated agent.

In some instances, the automated agent may automatically terminate the communication session in response to the impermissible communication or message and the corresponding indication from the moderation API. For example, as illustrated in FIG. 5, in addition to transmitting the response 506 to the user and indicating that the submitted user query 504 corresponds to an impermissible intent, the automated agent may update the interface 502 to provide a close session button 508. This close session button 508 may serve as an indication to the user that the communications session through the interface 502 has been terminated by the automated agent. In some instances, in addition to providing the close session button 508, the automated agent may disable the input field 510, which may prevent the user from transmitting new communications to the automated agent assigned to the communications session.

Based on the set of applicable rules, the user communication system may perform additional actions in response to detection of an impermissible intent. For example, in response to the user query 504, the automated agent, through the user communication system, may transmit a notification to a user's supervisor, a human resources system, or other authoritative entity that manages the user's role within a given organization to indicate that the user has submitted an impermissible user query through the interface 502. As another illustrative example, the user communication system may apply one or more restrictions to the user's account such that the user may be prohibited from accessing the interface 502 for a period of time (e.g., one day, one week, etc.). It should be noted that the aforementioned disciplinary actions are provided by way of example and any possible disciplinary actions are considered within the scope of the present disclosure.

As noted above, by automatically rejecting user communications or messages associated with impermissible intents, the moderation API implemented by the user communication system provides various computational benefits to the functioning of the user communication system. For instance, because the moderation API is configured to automatically reject any user communications that do not comport with any applicable rules, the user communication system does not have to process these user communications further, thereby reducing the processing requirements of the user communication system in generating responses to these impermissible user communications. Further, the moderation API increases the network security of the user communication system by automatically rejecting any communications that are not associated with permissible intents, preventing generation of responses that may include sensitive data or other data that the corresponding user may not be authorized to obtain.

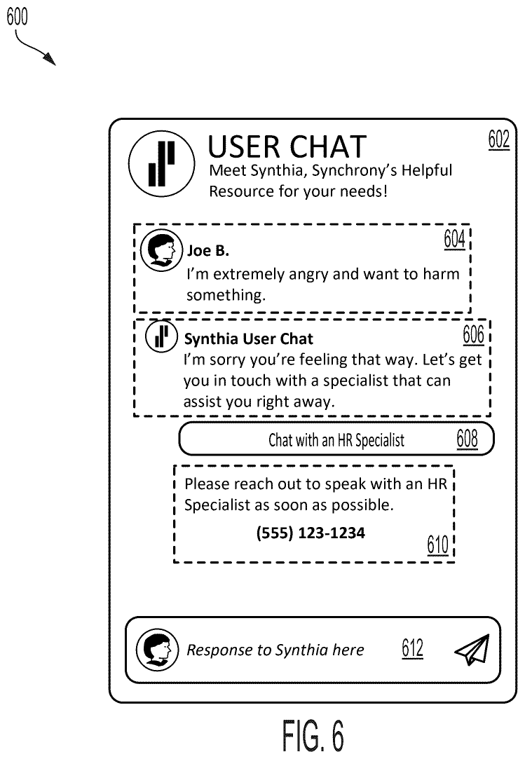

FIG. 6 shows an illustrative example of an environment 600 in which a user communication system provides user query responses 606-610 according to a detected user intent expressed in a user query 604 in accordance with at least one embodiment. In the environment 600, a user may be engaged in a communications session with an automated agent through an interface 602. The interface 602 may be similar to the interface 112 described above in connection with FIG. 1. As illustrated in FIG. 6, the user has transmitted a communication or message (e.g., user query 604) to the automated agent through the interface 602 indicating that they are experiencing a significant emotional issue and that they wish to harm themselves and/or others. This user query 604 may correspond to a legitimate use of the interface 602 and the user communication system.

As opposed to the illustrative example described above in connection with FIG. 5, the moderation API of the user communication system may determine that the intent expressed in the user query 604 corresponds to a permissible intent (e.g., the expressed intent does not violate any applicable rules and/or policies implemented by the user communication system). Accordingly, through the moderation API, the user query 604 may be transmitted in real-time or near real-time to an intent analyzer (e.g., intent analyzer 106 described above in connection with FIGS. 1 and 2) for further processing. As noted above, the intent analyzer implements NLP, which is dynamically trained to process user communications or messages obtained through the moderation API to convert these user communications or messages into sets of message embeddings. The NLP implemented by the intent analyzer may transmit this set of embeddings to an embedding comparison module of the intent analyzer to determine whether the user communication or message may be resolved using a known response. The embedding comparison module may perform clustering or classification of the embeddings corresponding to the user query 604 in real-time or near real-time to obtain partial matches among different known responses to identify the appropriate action to be performed (e.g., provide a known response to the user query 604). Further, if evaluation of embeddings of the user query 604 fail to satisfy a threshold for identification of an existing known response that may be used to address the user's intent, the embedding comparison module may automatically transfer the user query 604 to a RAG processor (such as RAG processor 108 described above in connection with FIGS. 1 and 3) for further processing and generation of a tailored response to the user's intent.

If the embedding comparison module determines that the set of embeddings corresponding to the user query 604 sufficiently matches a set of response embeddings corresponding to a known response, the embedding comparison module may provide the known response to the user through the aforementioned interface 602. For example, if the intent analyzer determines that the user query 604 corresponds to an intent (e.g., an expressed desire to cause harm due to an emotional state) for which known responses are available, the intent analyzer may transmit the known responses to the automated agent associated with ongoing communications session. These known responses may include a message 606 whereby the automated agent may express empathy towards the user and indicate that there are resources available to the user to address their emotional state. In addition to the message 606, the automated agent may update the interface 602 to present these resources. For example, in addition to the message 606, the automated agent may provide an action button 608 that the user may select to request a new communications session with a human resources specialist that may be able to further assist the user in addressing their emotional state. Further, the automated agent may provide, through an additional message 610, contact information corresponding to the human resources specialist that may be able to further assist the user in addressing their emotional state.

As noted above, in some instances, the set of embeddings of the user query 604 may fail to satisfy a threshold for identification of known responses for addressing the user's expressed intent. In such instances, the intent analyzer may transmit the user query 604 to the RAG processor for further processing. The RAG processor may include an NLP that may convert the user query 604 into a set of embeddings that may be processed using one or more LLMs and/or generative artificial intelligence processes supplemented using RAG to generate tailored responses to the user query 604. The RAG processor may maintain a knowledge base repository that is associated with myriad external and/or internal data sources made available to the user communication system for generating responses to any user queries. The knowledge base repository may be implemented to maintain various knowledge bases corresponding to these data sources and from which any supplemental data may be obtained to generate tailored responses to user queries. Each knowledge base within the knowledge base repository may include different sets of embeddings corresponding to data obtained from the myriad external and/or internal data sources.

Using the set of embeddings corresponding to the user query 604, the RAG processor may automatically query the knowledge base repository to identify different data sources that may be used to derive one or more responses to the user query 604. For example, the RAG processor may identify, from the knowledge base repository, a set of embeddings corresponding to different data sources or data elements that provide a threshold number of partial matches to the set of embeddings corresponding to the user query 604. Using these identified data sources or data elements, the RAG processor may dynamically generate one or more responses to the user query 604 and that include the associated data. As noted above, prior to the one or more newly generated responses being communicated to the user, the response may be processed through a response supervisor (such as response supervisor 110 described above in connection with FIGS. 1 and 4) to ensure that the one or more responses comport with any applicable rules and other controls. Thus, the responses 606-610 provided by the automated agent through the interface 602 may be automatically generated by the RAG processor using one or more knowledge bases derived from external and/or internal data sources.

In some instances, the user, through the input field 612, may transmit one or more new messages to the automated agent to provide feedback with regard to any of the responses 606-610 provided by the automated agent in response to the user query 604. These one or more subsequent new messages may be used to dynamically update the machine learning algorithms and/or artificial intelligence processes implemented by the intent analyzer and/or the RAG processor. For instance, if the responses 606-610 are generated by the intent analyzer and the responses 606-610 fail to address the intent expressed in the user query 604 (e.g., the user indicates that the responses 606-610 are irrelevant to the user's expressed intent, the user expresses frustration with the responses 606-610, the intent analyzer is unable to determine an action to be performed in response to the user query 604, etc.), the user query 604 may be evaluated to identify what appropriate action should have been performed in response to the user query 604 (e.g., what responses should have been generated by the intent analyzer, what actions should have been performed by the intent analyzer, etc.). This may include annotating the user query 604 to indicate the intent associated with the user query 604 and the particular known responses associated with the intent that should have been provided in response to the user query 604. The annotated user query may be added to the training dataset used to dynamically train the NLP and the embedding comparison module implemented by the intent analyzer. Thus, as the training dataset is updated, the machine learning algorithms and/or artificial intelligence used by the NLP and the embedding comparison module may be dynamically retrained or otherwise updated to improve identification of known responses or transfers to the RAG processor for generation of tailored responses to user queries.

Similarly, if the responses 606-610 are generated by the RAG processor, any feedback provided by the user with regard to the responses 606-610 may be used to retrain or otherwise update the LLMs and/or generative artificial intelligence processes implemented by the RAG processor. As noted above, a response supervisor implemented by the user communication system may evaluate a proposed response message according to different linguistic metrics to determine whether the proposed response message is likely to be understood by the user. If the proposed response message fails any of these evaluations according to the set of thresholds, the response supervisor may reject the proposed response message and provide feedback to the RAG processor that may be used to dynamically retrain the one or more LLMs or other generative artificial intelligence processes. If the user expresses, in response to the responses 606-610, confusion or lack of understanding of the responses 606-610, this may serve as an indication that the responses 606-610 were not positively received by the user. Accordingly, the responses 606-610 and the corresponding user query 604 may be annotated to include this negative feedback, as well as any actions to be taken to address the negative feedback (e.g., indication of areas for improvement of the responses 606-610, corrections to the responses 606-610, expected responses to the user query 604, etc.). These annotations may be added to the training dataset and used to dynamically retrain or otherwise update the LLMs and/or generative artificial intelligence processes implemented by the RAG processor.

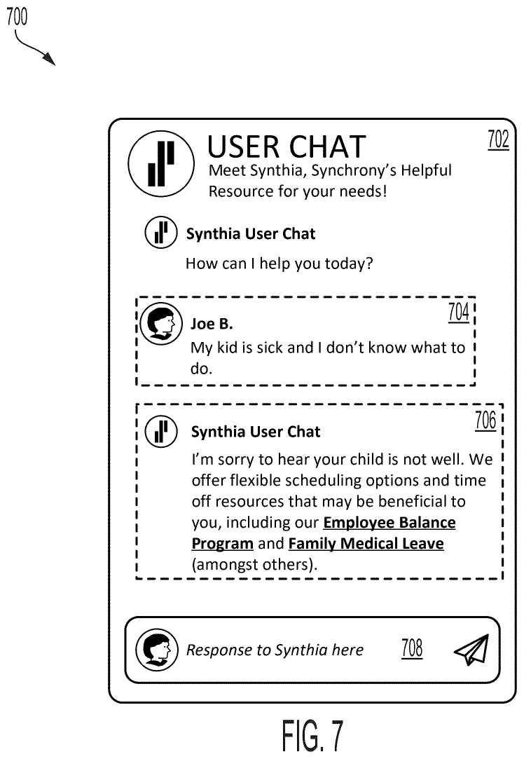

FIG. 7 shows an illustrative example of an environment 700 in which a user communication system provides a user query response 706 including resources for addressing a detected user intent expressed in a user query 704 in accordance with at least one embodiment. In the environment 700, a user may be engaged in a communications session with an automated agent through an interface 702. The interface 702 may be similar to the interface 112 described above in connection with FIG. 1. As illustrated in FIG. 7, the user has transmitted a communication or message (e.g., user query 704) to the automated agent through the interface 702 indicating that they have a sick child and does not know what to do to address this. This user query 604 may correspond to a legitimate use of the interface 702 and the user communication system. Further, the user query 704 may correspond to an intent for which the user communication system maintains various known responses that may be provided to the user.

As noted above, the user communication system providing the interface 702 used to facilitate the communications session between the user and an automated agent may implement an intent analyzer that is used to identify intents expressed in user queries and based on these intents, determine whether these intents may be addressed using known responses or are to be transferred to a RAG processor for further processing and response generation. The intent analyzer implements NLP, which is dynamically trained to process user queries to convert these user queries into sets of message embeddings. The NLP implemented by the intent analyzer may transmit the set of embeddings corresponding to the user query 704 to an embedding comparison module of the intent analyzer to determine whether the user query 704 may be resolved using a known response. The embedding comparison module may perform clustering or classification of the embeddings corresponding to the user query 704 in real-time or near real-time to obtain partial matches among different known responses to identify the appropriate action to be performed.

In the example provided in FIG. 7, the user query 704 corresponds to a known response maintained by the intent analyzer. This known response may have been previously stored in a known response repository of the intent analyzer by the user communication system or other entity (e.g., organization that implements the user communication system, employer of the user, etc.) based on one or more FAQs or other documents supplied by the user communication system or other entity. Additionally, or alternatively, the known response may have been previously added to the known response repository as a result of the known response being generated a threshold number of times by the RAG processor according to similar intents expressed by different users of the user communication system over time. For example, if the RAG processor generates a threshold number of responses according to one or more internal and/or external data sources and for intents associated with personal and sick leave inquiries, the RAG processor may automatically provide these responses to the intent analyzer for generation of a known response for these similar intents. This known response may be converted into a set of embeddings and added to the known response repository maintained by the intent analyzer.

The embedding comparison module implemented by the intent analyzer may compare the set of embeddings corresponding to the user query 704 to the different sets of embeddings corresponding to the known responses and corresponding resources maintained in the known response repository. In this example, the embedding comparison module may identify, from the known response repository, a known response whose partial matches with the embeddings of the user query 704 satisfy a match threshold for identifying an appropriate known response. Accordingly, the embedding comparison module may obtain, from the known response repository, the corresponding known response and any corresponding resources. Using this known response and the identified corresponding resources (if any), the embedding comparison module may generate a response 706 that may be used to address the user query 704. For example, the response 706 may include an indication of an employee balance program and of a family medical leave policy that may be useful to the user in addressing their concern over their sick child. Further, the response 706 may include links to the program and the policy stated in the response 706.

In some instances, the user, through the input field 708, may transmit one or more new messages to the automated agent to provide feedback with regard to the response 706 provided by the automated agent in response to the user query 704. These one or more subsequent new messages may be used to dynamically update the machine learning algorithms and/or artificial intelligence processes implemented by the intent analyzer. For instance, if the response 706 generated by the intent analyzer fails to address the intent expressed in the user query 704, the user query 704 may be evaluated to identify what appropriate action should have been performed in response to the user query 704 (e.g., what known response should have been selected by the intent analyzer for generating the response 706, whether the user query 704 should have been transferred to the RAG processor due to a lack of a known response to the intent, etc.). This may include annotating the user query 704 to indicate the intent associated with the user query 704 and the particular known responses and/or resources associated with the intent that should have been provided in response to the user query 704. The annotated user query may be added to the training dataset used to dynamically train the NLP and the embedding comparison module implemented by the intent analyzer. Thus, as the training dataset is updated, the machine learning algorithms and/or artificial intelligence used by the NLP and the embedding comparison module may be dynamically retrained or otherwise updated to improve identification of known responses or to determine when user queries should be transferred to the RAG processor for generation of tailored responses to user queries.

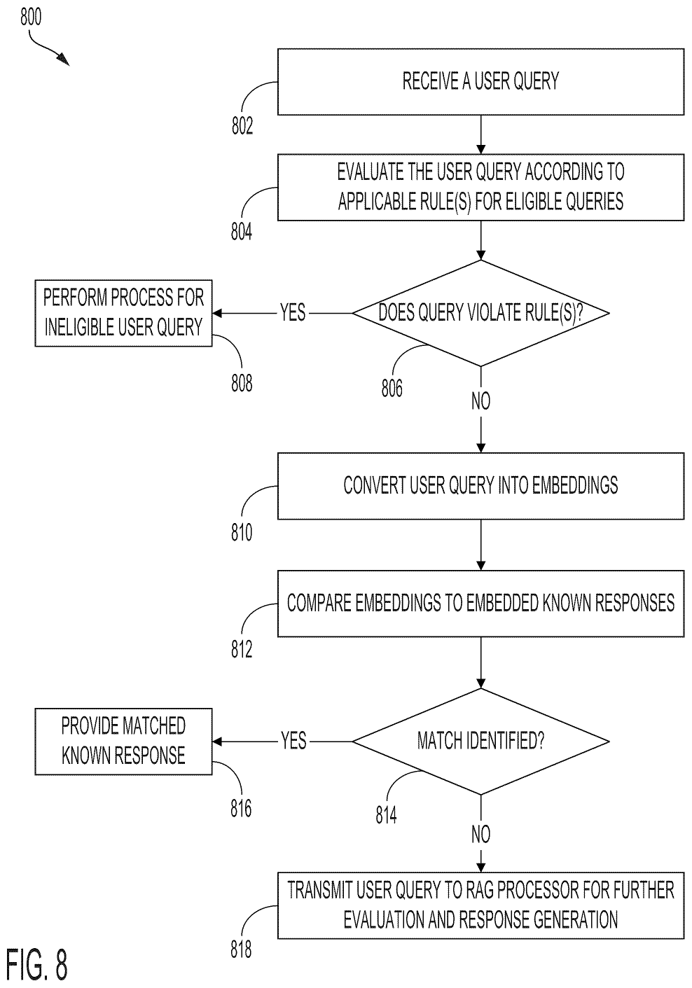

FIG. 8 shows an illustrative example of a process 800 for evaluating a set of embeddings corresponding to a user query according to a set of applicable rules and known responses to determine how to process the user query in accordance with at least one embodiment. The process 800 may be performed by a user communication system through a moderation API and an intent analyzer implemented by the user communication system. At step 802 of the process 800, the user communication system may receive a user query. The user query may be submitted by a user of the user communication system through an ongoing communications session between the user and an automated agent. As noted above, this ongoing communications session may be facilitated through an interface provided by the user communication system through an application that may be installed and executed from the user's computing device. Additionally, or alternatively, the interface may be provided through a website associated with the user communication system and through which the user communication system implements a web service that includes the interface. The user query may be received in real-time or near real-time as the user query is submitted through the interface to the automated agent for processing and response.

As noted above, any newly received user query may be initially processed through a moderation API to ensure that the user query comports with any applicable rules, controls, and/or policies. Thus, at step 804, the user communication system, through the moderation API, may evaluate the received user query according to these applicable rules, controls, and/or policies to determine, at step 806, whether the user query violates any of these applicable rules, controls, and/or policies. For instance, in response to the new user query, the moderation API may apply NLP or any other text parsing algorithm or executable code to automatically parse the new communication or message. Through this parsing of the new communication or message, the moderation API may identify particular terms that may be used to determine a user intent expressed by the user. The applicable rules, controls, and/or policies may specify what intents may be processed by the user communication system as well as any actions that are to be performed in the event that a user submits an impermissible intent in a user query. Thus, based on the user intent extracted from the user query and the applicable rules, controls, and/or policies, the moderation API may determine whether the user query includes a permissible or impermissible intent.

If the user query is associated with an impermissible intent, the user communication system, at step 808 and through the moderation API, may perform a process corresponding to an ineligible user query. For example, as part of this process, the user communication system may cause the automated agent to transmit a response to the user to indicate that the submitted user query could not be processed. In some instances, the automated agent may automatically generate a response that admonishes the user for submitting an impermissible user query to the automated agent through the interface. In some instances, the automated agent may automatically terminate the communication session in response to the impermissible user query and the corresponding indication from the moderation API. In some instances, the automated agent, through the user communication system, may transmit a notification to a user's supervisor, a human resources system, or other authoritative entity that manages the user's role within a given organization to indicate that the user has submitted an impermissible user query through the interface. In another illustrative example, the user communication system may apply one or more restrictions to the user's account such that the user may be prohibited from accessing the interface for a period of time (e.g., one day, one week, etc.). It should be noted that the aforementioned actions are provided by way of example and any possible actions to address ineligible user queries are considered within the scope of the present disclosure.

If the user communication system, through the moderation API, determines that the user query is associated with a permissible intent, the user communication system may transmit the user query to an intent analyzer for further processing. The intent analyzer, at step 810, may convert the user query into a set of embeddings using NLP. As noted above, the intent analyzer may include an embedding comparison module that implements a machine learning algorithm or artificial intelligence that is dynamically trained to compare received sets of embeddings to embeddings corresponding to known responses. These known responses may be generated by the user communication system or other entity associated with the user communication system based on different available resources. In response to receiving the set of embeddings corresponding to the user query, the embedding comparison module, at step 812, may compare this set of embeddings to the different sets of embeddings corresponding to known responses maintained by the intent analyzer. For instance, through the aforementioned machine learning algorithm or artificial intelligence, the embedding comparison module may perform clustering or classification of the user query to obtain partial matches among different known responses to determine whether there is a known response that sufficiently matches the intent associated with the user query (e.g., an obtained partial match satisfies a matching threshold for selection of a known response).

If the intent analyzer, through evaluation of the set of embeddings corresponding to the user query and the different sets of embeddings corresponding to available known responses, fails to identify an existing known response that may be used to address the user's intent, the embedding comparison module, at step 818, may automatically transfer the user query to the RAG processor for further processing and generation of a tailored response to the user's intent. Alternatively, if the embedding comparison module determines that the set of embeddings corresponding to a received user query sufficiently matches a set of response embeddings corresponding to a known response (e.g., the partial matches between the user query and the known response satisfy the aforementioned threshold, etc.), the embedding comparison module, at step 816, may provide the known response to the user through the aforementioned interface, as described above.

It should be noted that the process 800 may be performed continuously and simultaneously for different user queries corresponding to different communications sessions as these user queries are communicated through these different communications sessions. For instance, the user communication system, through the moderation API and the intent analyzer, may continuously and simultaneously process these different user queries as the different user queries are received to identify and process any ineligible user queries, as well as identify known responses that may be provided for particular user queries whose expressed intents correspond to the known responses. Further, for any user queries that the intent analyzer determines are not associated with a known response, the intent analyzer may continuously and simultaneously transmit these user queries to the RAG process for further evaluation and response generation. Thus, the user communication system, through the moderation API and the intent analyzer, may continuously and simultaneously process any number of user queries in real-time or near real-time as these user queries are received to filter out any ineligible user queries, provide known responses to user queries for which known responses are available, and transfer user queries requiring additional evaluation to the RAG processor for response generation.

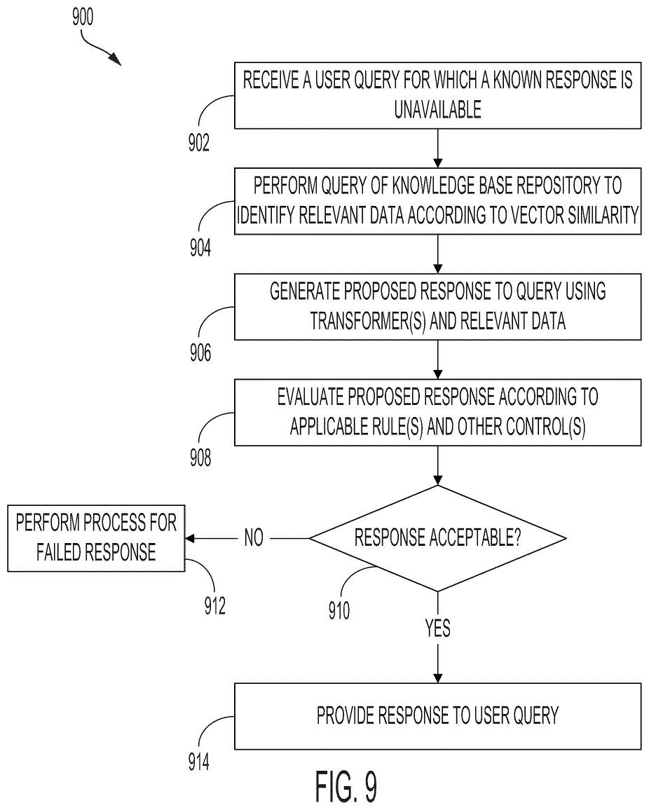

FIG. 9 shows an illustrative example of a process 900 for generating a user query response to a user query through a RAG processor and based on identified relevant data embeddings in accordance with at least one embodiment. The process 900 may be performed by a RAG processor in conjunction with a response supervisor implemented by the user communication system. The process 900 may be a continuation of the process 800 described above in connection with FIG. 8. For instance, if the intent analyzer implemented by the user communication system determines that a user query cannot be resolved using a known response maintained by the intent analyzer, the intent analyzer may automatically transmit this user query to the RAG processor for further evaluation and response generation (e.g., step 818 of the process 800 described above in connection with FIG. 8). Accordingly, at step 902, the RAG processor may receive a user query for which a known response is unavailable or otherwise not identified by the intent analyzer.

At step 904, the RAG processor may perform a query of its knowledge base repository to identify relevant data according to one or more vectors of similarity. As noted above, the RAG processor is implemented in conjunction with one or more LLMs and/or other generative artificial intelligence processes that are dynamically trained to generate responses to user queries based on evaluation of myriad data sources available to the RAG processor. The RAG processor may maintain a knowledge base repository or other datastore that is associated with myriad external and/or internal data sources made available to the user communication system for generating responses to any user communications or messages. In an embodiment, the RAG processor, through this knowledge base repository or other datastore, maintains different embeddings corresponding to different internal and external data sources made available to the RAG processor for generating responses to received communications or messages. For instance, the RAG processor may automatically access or scrape any available data sources within these one or more data sources and, accordingly, convert the data includes in these data sources into different sets of embeddings that may be used to dynamically generate responses to received communications or messages.

In response to the user query, the RAG processor may convert the user query into a set of embeddings that may be evaluated against the different sets of embeddings corresponding to the different internal and external data sources made available to the RAG processor for generating responses to received communications or messages. Similar to the process 800 described above in connection with FIG. 8, the RAG processor may compare, according to a set of vectors of similarity, the set of embeddings corresponding to the user query to the different sets of embeddings corresponding to the different data sources/knowledge bases maintained by the RAG processor. For instance, the RAG processor may perform clustering or classification of the user query to obtain partial matches among different data sources/knowledge bases to identify one or more data sources/knowledge bases that may be used to derive a response to the user query.

At step 906, the RAG processor may generate a proposed response to the user query using the LLMs and/or other generative artificial intelligence processes (e.g., transformers, etc.) and the identified data sources/knowledge bases. As noted above, prior to the newly generated response being communicated to the user in response to their user query, the response may be processed through a response supervisor to ensure that the response comports with any applicable rules and other controls. Thus, at step 908, the response supervisor may evaluate the proposed response message, as well as any information associated with the user, to determine whether the proposed response message may be communicated to the user. As noted above, in some instances, the user communication system, in response to a user request to initiate a communications session with an automated agent, may assess the user's role within an organization or other entity to identify the permissible intents that may be communicated by the user. The response supervisor may evaluate a proposed response message to determine whether the proposed response message includes any information or other data that the user, based on their defined role, is not authorized to access. The response supervisor may further evaluate a proposed response message according to different linguistic metrics to determine whether the proposed response message is likely to be understood by the user. For instance, the response supervisor may maintain, for each of these different linguistic metrics, a set of thresholds that may need to be satisfied in order for the proposed response message to be accepted by the response supervisor and transmitted to the user.

Based on this evaluation of the proposed response, the response supervisor, at step 910, may determine whether the proposed response is acceptable for transmission to the user. For instance, if the proposed response message fails any of the aforementioned evaluations according to the set of metrics thresholds, the response supervisor, at step 912, may perform a process corresponding to a failed proposed response. For instance, the response supervisor may automatically reject the proposed response message and provide feedback to the RAG processor that may be used to dynamically retrain the one or more LLMs or other generative artificial intelligence processes implemented by the RAG processor. Similarly, if the proposed response message includes impermissible information or other data that the user is not authorized to access or receive, the response supervisor may reject the proposed response message. This rejection of the proposed response message may serve as feedback that may be used to dynamically retrain the one or more LLMs or other generative artificial intelligence processes implemented by the RAG processor.

If the response supervisor determines that the proposed response may be communicated to the user in response to their user query, the response supervisor, at step 914, may provide this response to the user through the ongoing communications session. For instance, the response supervisor, through the automated agent associated with the ongoing communications session, may provide the response message to the user through the interface through which the ongoing communications session is being facilitated. As noted above, as user interacts with the response message (e.g., submits their own responses to the response message, submits new user queries, etc.), the user communication system may dynamically process these interactions through the aforementioned components to generate new response messages and to dynamically retrain any of the aforementioned machine learning algorithms or artificial intelligence processes to provide improved responses to user communications and messages.

Similar to the process 800 described above in connection with FIG. 8, it should be noted that the process 900 may be performed continuously and simultaneously for different user queries corresponding to different communications sessions as these user queries are communicated through these different communications sessions. For instance, the user communication system, through the RAG processor, may continuously and simultaneously process these different user queries as the different user queries are received to identify any relevant data sources, as well as generate proposed responses to these user queries using the identified relevant data sources. Further, for any proposes responses generated by the RAG processor, the response supervisor may continuously and simultaneously evaluate these proposed responses according to any applicable rules, controls, and/or policies to ensure that the corresponding users are authorized to receive the proposed responses, that the proposed responses are likely to be understood by these users, and that the proposed responses accurately address the intents expressed by these users. Thus, the user communication system, through the RAG processor and the response supervisor, may continuously and simultaneously process any number of user queries in real-time or near real-time as these user queries are received to generate proposed responses and ensure that the proposed responses comport with applicable rules, controls, and/or policies.

FIG. 10 illustrates a computing system architecture 1000, including various components in electrical communication with each other, in accordance with some embodiments. The example computing system architecture 1000 illustrated in FIG. 10 includes a computing device 1002, which has various components in electrical communication with each other using a connection 1006, such as a bus, in accordance with some implementations. The example computing system architecture 1000 includes a processing unit 1004 that is in electrical communication with various system components, using the connection 1006, and including the system memory 1014. In some embodiments, the system memory 1014 includes read-only memory (ROM), random-access memory (RAM), and other such memory technologies including, but not limited to, those described herein. In some embodiments, the example computing system architecture 1000 includes a cache 1008 of high-speed memory connected directly with, in close proximity to, or integrated as part of the processor 1004. The system architecture 1000 can copy data from the memory 1014 and/or the storage device 1010 to the cache 1008 for quick access by the processor 1004. In this way, the cache 1008 can provide a performance boost that decreases or eliminates processor delays in the processor 1004 due to waiting for data. Using modules, methods and services such as those described herein, the processor 1004 can be configured to perform various actions. In some embodiments, the cache 1008 may include multiple types of cache including, for example, level one (L1) and level two (L2) cache. The memory 1014 may be referred to herein as system memory or computer system memory. The memory 1014 may include, at various times, elements of an operating system, one or more applications, data associated with the operating system or the one or more applications, or other such data associated with the computing device 1002.

Other system memory 1014 can be available for use as well. The memory 1014 can include multiple different types of memory with different performance characteristics. The processor 1004 can include any general purpose processor and one or more hardware or software services, such as service 1012 stored in storage device 1010, configured to control the processor 1004 as well as a special-purpose processor where software instructions are incorporated into the actual processor design. The processor 1004 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1004 can be a microprocessor, a microcontroller, a digital signal processor (“DSP”), or a combination of these and/or other types of processors. In some embodiments, the processor 1004 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1000, an input device 1016 can represent any number of input mechanisms, such as a microphone for speech, a touch-sensitive screen for gesture or graphical input, keyboard, mouse, motion input, pen, and other such input devices. An output device 1018 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1000. In some embodiments, the input device 1016 and/or the output device 1018 can be coupled to the computing device 1002 using a remote connection device such as, for example, a communication interface such as the network interface 1020 described herein. In such embodiments, the communication interface can govern and manage the input and output received from the attached input device 1016 and/or output device 1018. As may be contemplated, there is no restriction on operating on any particular hardware arrangement and accordingly the basic features here may easily be substituted for other hardware, software, or firmware arrangements as they are developed.

In some embodiments, the storage device 1010 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 1010 can include hardware and/or software services such as service 1012 that can control or configure the processor 1004 to perform one or more functions including, but not limited to, the methods, processes, functions, systems, and services described herein in various embodiments. In some embodiments, the hardware or software services can be implemented as modules. As illustrated in example computing system architecture 1000, the storage device 1010 can be connected to other parts of the computing device 1002 using the system connection 1006. In an embodiment, a hardware service or hardware module such as service 1012, that performs a function can include a software component stored in a non-transitory computer-readable medium that, in connection with the necessary hardware components, such as the processor 1004, connection 1006, cache 1008, storage device 1010, memory 1014, input device 1016, output device 1018, and so forth, can carry out the functions such as those described herein.

The payment instrument service, the systems of the payment instrument, and the systems and methods for dynamically providing real-time intent analysis and resolution can be performed using a computing system such as the example computing system illustrated in FIG. 10, using one or more components of the example computing system architecture 1000. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically providing real-time intent analysis and resolution described herein by, for example, executing code using a processor such as processor 1004 wherein the code is stored in memory such as memory 1014 as described herein. One or more of a user device, a provider server or system, a database system, or other such devices, services, or systems may include some or all of the components of the computing system such as the example computing system illustrated in FIG. 10, using one or more components of the example computing system architecture 1000 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1028. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1004 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1014 can be coupled to the processor 1004 by, for example, a connector such as connector 1006, or a bus. As used herein, a connector or bus such as connector 1006 is a communications system that transfers data between components within the computing device 1002 and may, in some embodiments, be used to transfer data between computing devices. The connector 1006 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1014 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1014 can also include magnetic or optical data storage media including read-only (e.g., CD ROM and DVD ROM) or otherwise (e.g., CD or DVD). The memory can be local, remote, or distributed.

As described herein, the connector 1006 (or bus) can also couple the processor 1004 to the storage device 1010, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1010. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1006 can also couple the processor 1004 to a network interface device such as the network interface 1020. The interface can include one or more of a modem or other such network interfaces including, but not limited to those described herein. It will be appreciated that the network interface 1020 may be considered to be part of the computing device 1002 or may be separate from the computing device 1002. The network interface 1020 can include one or more of an analog modem, Integrated Services Digital Network (ISDN) modem, cable modem, token ring interface, satellite transmission interface, or other interfaces for coupling a computer system to other computer systems. In some embodiments, the network interface 1020 can include one or more input and/or output (I/O) devices. The I/O devices can include, by way of example but not limitation, input devices such as input device 1016 and/or output devices such as output device 1018. For example, the network interface 1020 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1002 can be connected to one or more additional computing devices such as computing device 1024 via a network 1022 using a connection such as the network interface 1020. In such embodiments, the computing device 1024 may execute one or more services 1026 to perform one or more functions under the control of, or on behalf of, programs and/or services operating on computing device 1002. In some embodiments, a computing device such as computing device 1024 may include one or more of the types of components as described in connection with computing device 1002 including, but not limited to, a processor such as processor 1004, a connection such as connection 1006, a cache such as cache 1008, a storage device such as storage device 1010, memory such as memory 1014, an input device such as input device 1016, and an output device such as output device 1018. In such embodiments, the computing device 1024 can carry out the functions such as those described herein in connection with computing device 1002. In some embodiments, the computing device 1002 can be connected to a plurality of computing devices such as computing device 1024, each of which may also be connected to a plurality of computing devices such as computing device 1024. Such an embodiment may be referred to herein as a distributed computing environment.

The network 1022 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1022 can be wired connections, wireless connections, or combinations thereof. Communications via the network 1022 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1022, within the computing device 1002, within the computing device 1024, or within the computing resources provider 1028 can include information, which also may be referred to herein as content. The information may include text, graphics, audio, video, haptics, and/or any other information that can be provided to a user of the computing device such as the computing device 1002. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1002 and presented to a user of the computing device 1002 using forms that are perceptible via sight, sound, smell, taste, touch, or other such mechanisms. In some embodiments, communications over the network 1022 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1002 and/or the computing device 1024 can be connected to a computing resources provider 1028 via the network 1022 using a network interface such as those described herein (e.g. network interface 1020). In such embodiments, one or more systems (e.g., service 1030 and service 1032) hosted within the computing resources provider 1028 (also referred to herein as within “a computing resources provider environment”) may execute one or more services to perform one or more functions under the control of, or on behalf of, programs and/or services operating on computing device 1002 and/or computing device 1024. Systems such as service 1030 and service 1032 may include one or more computing devices such as those described herein to execute computer code to perform the one or more functions under the control of, or on behalf of, programs and/or services operating on computing device 1002 and/or computing device 1024.

For example, the computing resources provider 1028 may provide a service, operating on service 1030 to store data for the computing device 1002 when, for example, the amount of data that the computing device 1002 exceeds the capacity of storage device 1010. In another example, the computing resources provider 1028 may provide a service to first instantiate a virtual machine (VM) on service 1032, use that VM to access the data stored on service 1032, perform one or more operations on that data, and provide a result of those one or more operations to the computing device 1002. Such operations (e.g., data storage and VM instantiation) may be referred to herein as operating “in the cloud,” “within a cloud computing environment,” or “within a hosted virtual machine environment,” and the computing resources provider 1028 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1028 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 1030 and service 1032 may implement versions of various services (e.g., the service 1012 or the service 1026) on behalf of, or under the control of, computing device 1002 and/or computing device 1024. Such implemented versions of various services may involve one or more virtualization techniques so that, for example, it may appear to a user of computing device 1002 that the service 1012 is executing on the computing device 1002 when the service is executing on, for example, service 1030. As may also be contemplated, the various services operating within the computing resources provider 1028 environment may be distributed among various systems within the environment as well as partially distributed onto computing device 1024 and/or computing device 1002.

In an embodiment, the computing device 1002 can be connected to one or more additional computing devices and/or services such as merchant computing device 1036 and/or a point-of-sale service 1034 via the network 1022 and using a connection such as the network interface 1020. In an embodiment, the point-of-sale service 1034 is separate from the merchant computing device 1036. In an embodiment, the point-of-sale service 1034 is executing on the merchant computing device 1036. In an embodiment, the point-of-sale service 1034 is executing as one or more services (e.g., the service 1030 and/or the service 1032) operating within the environment of the computing resources provider. As used herein, a point-of-sale service 1034 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 1036 to interact with the point-of-sale service 1034. In an embodiment, the merchant computing device 1036 is a dedicated point-of-service (POS) terminal. In an embodiment, the merchant computing device 1036 is a cash register system. In an embodiment, the merchant computing device 1036 is an application or web service operating on a computing device such as the computing device 1002 described herein. In such an embodiment, the application or web service may be provided by a financial services system (e.g., a bank, a transaction processing system, an inventory management system, or some other such financial services system). In an embodiment, the merchant computing device 1036 includes an auxiliary device or system to execute tasks associated with the point-of-sale service 1034 (e.g., a payment instrument processing device attached to a smart phone or tablet). In an embodiment, the merchant computing device 1036 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 1036 is a virtual device (e.g., a virtual kiosk) such as the virtual devices described herein. Although not illustrated here, in an embodiment, the merchant computing device 1036 may be one of a plurality of devices that may be interconnected using a network such as the network 1022.

In an embodiment, the computing device 1002 can be connected to one or more additional computing devices and/or services such as a payment instrument service 1038 via the network 1022 and using a connection such as the network interface 1020. In an embodiment, the payment instrument service 1038 connects directly with the point of sale service 1034. In an embodiment, elements of the payment instrument service 1038 are executing on the merchant computing device 1036. In an embodiment, the payment instrument service 1038 is executing as one or more services (e.g., the service 1030 and/or the service 1032) operating within the environment of the computing resources provider. As used herein, a payment instrument service 1038 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 1038 are running as an application or web service operating on a computing device such as the computing device 1002 described herein. In such an embodiment, the application or web service of the payment instrument service 1038 may be provided by a financial services system (e.g., a bank, a transaction processing system, an inventory management system, or some other such financial services system). In an embodiment, elements of the payment instrument service 1038 are running on an auxiliary device or system configured to execute tasks associated with the payment instrument service 1038 (e.g., uses a payment instrument processing device attached to a smart phone or tablet). In an embodiment, elements of the payment instrument service 1038 are running on virtual device such as those described herein. Although not illustrated here, in an embodiment, the payment instrument service 1038 may be running on one or more of a plurality of devices that may be interconnected using a network such as the network 1022.

In an embodiment, the computing device 1002 can be connected to one or more additional computing devices and/or services such as a evaluation service 1040 via the network 1022 and using a connection such as the network interface 1020. In an embodiment, the evaluation service 1040 is an element of the payment instrument service 1038. In an embodiment, the evaluation service 1040 is separate from the payment instrument service 1038. In an embodiment, the evaluation service 1040 connects directly with the point of sale service 1034. In an embodiment, elements of the evaluation service 1040 are executing on the merchant computing device 1036. In an embodiment, the evaluation service 1040 is executing as one or more services (e.g., the service 1030 and/or the service 1032) operating within the environment of the computing resources provider. As used herein, a evaluation service 1040 is a service used by one or more merchants to authenticate transactions associated with payment instruments. An authentication service may be a third-party service that provides secure and verified authorization of the transactions.

In an embodiment, elements of the evaluation service 1040 are running as an application or web service operating on a computing device such as the computing device 1002 described herein. In such an embodiment, the application or web service of the authentication service 1040 may be provided by a financial services system (e.g., a bank, a transaction processing system, an inventory management system, or some other such financial services system). In an embodiment, elements of the evaluation service 1040 are running on an auxiliary device or system configured to execute tasks associated with the evaluation service 1040 (e.g., provides authentication using payment instrument processing device attached to a smart phone or tablet). In an embodiment, elements of the evaluation service 1040 are running on virtual device such as those described herein. Although not illustrated here, in an embodiment, the evaluation service 1040 may be running on one or more of a plurality of devices that may be interconnected using a network such as the network 1022.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1002) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1002.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
receiving a user query, wherein the user query is associated with an intent, and wherein the user query is received during an ongoing communications session between a user and an automated agent;
dynamically converting the user query into a set of embeddings, wherein the set of embeddings are obtained through language processing of the user query;
identifying a set of response embeddings, wherein the set of response embeddings correspond to one or more data sources relevant to the user query, and wherein the set of response embeddings are identified through processing of the set of embeddings and different response embeddings according to a set of similarity vectors;
generating a response to the user query and the intent, wherein the response is generated by one or more generative pre-trained transformers according to the set of response embeddings;
providing the response to the user query, wherein the response is provided by the automated agent through the ongoing communications session; and
updating the one or more generative pre-trained transformers according to feedback associated with the response.

2. The computer-implemented method of claim 1, further comprising:
receiving a new user query, wherein the new user query is associated with an impermissible intent; and
automatically rejecting the new user query, wherein the new user query is automatically rejected based on the impermissible intent.

3. The computer-implemented method of claim 1, wherein the set of embeddings and the different response embeddings are processed using retrieval augmented generation to identify the set of response embeddings.

4. The computer-implemented method of claim 1, further comprising:
receiving a new user query, wherein the new user query is associated with a known intent; and
automatically transmitting a known response to the new user query through the ongoing communications session, wherein the known response is identified through a matching of a set of new embeddings corresponding to the new user query and a set of known response embeddings corresponding to the known response.

5. The computer-implemented method of claim 1, further comprising:
identifying a role associated with the user; and
selecting the one or more data sources according to the role.

6. The computer-implemented method of claim 1, further comprising:
storing a record of the response to the user query, wherein the record is associated with the user; and
automatically surfacing the record in response to user initiation of a new communications session.

7. The computer-implemented method of claim 1, further comprising:
evaluating the response through one or more other generative pre-trained transformers according to a set of controls, wherein the response is provided as a result the response satisfying the set of controls.

8. A system, comprising:
one or more processors; and
memory storing thereon instructions that, as a result of being executed by the one or more processors, cause the system to:
receive a user query, wherein the user query is associated with an intent, and wherein the user query is received during an ongoing communications session between a user and an automated agent;
dynamically convert the user query into a set of embeddings, wherein the set of embeddings are obtained through language processing of the user query;
identify a set of response embeddings, wherein the set of response embeddings correspond to one or more data sources relevant to the user query, and wherein the set of response embeddings are identified through processing of the set of embeddings and different response embeddings according to a set of similarity vectors;
generate a response to the user query and the intent, wherein the response is generated by one or more generative pre-trained transformers according to the set of response embeddings;
provide the response to the user query, wherein the response is provided by the automated agent through the ongoing communications session; and
update the one or more generative pre-trained transformers according to feedback associated with the response.

9. The system of claim 8, wherein the instructions further cause the system to:
receive a new user query, wherein the new user query is associated with an impermissible intent; and
automatically reject the new user query, wherein the new user query is automatically rejected based on the impermissible intent.

10. The system of claim 8, wherein the set of embeddings and the different response embeddings are processed using retrieval augmented generation to identify the set of response embeddings.

11. The system of claim 8, wherein the instructions further cause the system to:
receive a new user query, wherein the new user query is associated with a known intent; and
automatically transmit a known response to the new user query through the ongoing communications session, wherein the known response is identified through a matching of a set of new embeddings corresponding to the new user query and a set of known response embeddings corresponding to the known response.

12. The system of claim 8, wherein the instructions further cause the system to:
identify a role associated with the user; and
select the one or more data sources according to the role.

13. The system of claim 8, wherein the instructions further cause the system to:
store a record of the response to the user query, wherein the record is associated with the user; and
automatically surface the record in response to user initiation of a new communications session.

14. The system of claim 8, wherein the instructions further cause the system to:
evaluate the response through one or more other generative pre-trained transformers according to a set of controls, wherein the response is provided as a result the response satisfying the set of controls.

15. A non-transitory, computer-readable storage medium storing thereon executable instructions that, as a result of being executed by one or more processors of a computer system, cause the computer system to:
receive a user query, wherein the user query is associated with an intent, and wherein the user query is received during an ongoing communications session between a user and an automated agent;
dynamically convert the user query into a set of embeddings, wherein the set of embeddings are obtained through language processing of the user query;
identify a set of response embeddings, wherein the set of response embeddings correspond to one or more data sources relevant to the user query, and wherein the set of response embeddings are identified through processing of the set of embeddings and different response embeddings according to a set of similarity vectors;
generate a response to the user query and the intent, wherein the response is generated by one or more generative pre-trained transformers according to the set of response embeddings;
provide the response to the user query, wherein the response is provided by the automated agent through the ongoing communications session; and
update the one or more generative pre-trained transformers according to feedback associated with the response.

16. The non-transitory, computer-readable storage medium of claim 15, wherein the executable instructions further cause the computer system to:
receive a new user query, wherein the new user query is associated with an impermissible intent; and
automatically reject the new user query, wherein the new user query is automatically rejected based on the impermissible intent.

17. The non-transitory, computer-readable storage medium of claim 15, wherein the set of embeddings and the different response embeddings are processed using retrieval augmented generation to identify the set of response embeddings.

18. The non-transitory, computer-readable storage medium of claim 15, wherein the executable instructions further cause the computer system to:
receive a new user query, wherein the new user query is associated with a known intent; and
automatically transmit a known response to the new user query through the ongoing communications session, wherein the known response is identified through a matching of a set of new embeddings corresponding to the new user query and a set of known response embeddings corresponding to the known response.

19. The non-transitory, computer-readable storage medium of claim 15, wherein the executable instructions further cause the computer system to:
identify a role associated with the user; and
select the one or more data sources according to the role.

20. The non-transitory, computer-readable storage medium of claim 15, wherein the executable instructions further cause the computer system to:
store a record of the response to the user query, wherein the record is associated with the user; and
automatically surface the record in response to user initiation of a new communications session.

21. The non-transitory, computer-readable storage medium of claim 15, wherein the executable instructions further cause the computer system to:
evaluate the response through one or more other generative pre-trained transformers according to a set of controls, wherein the response is provided as a result the response satisfying the set of controls.
